(19) United States
(12) Patent Application Publication
(10) Pub. No.: US 2018/0278625 A1
(43) Pub. Date: Sep. 27, 2018

(54) EXCHANGING MESSAGE AUTHENTICATION CODES FOR ADDITIONAL SECURITY IN A COMMUNICATION SYSTEM

(71) Applicant: QUALCOMM Incorporated, San Diego, CA (US)

(72) Inventors: Rosario CAMMAROTA, San Diego, CA (US); Sai Yiu Duncan HO, San Diego, CA (US); Brian Michael BUESKER, San Diego, CA (US); Alireza RAISSINIA, Monte Sereno, CA (US); George CHERIAN, San Diego, CA (US)

(21) Appl. No.: 15/933,198

(22) Filed: Mar. 22, 2018

Related U.S. Application Data
(60) Provisional application No. 62/476,663, filed on Mar. 24, 2017.

(51) Int. Cl. H04L 29/06; H04W 12/06; H04L 9/32; H04L 9/08

(52) U.S. Cl. CPC H04L 63/123; H04W 12/06; H04L 9/3263; H04L 9/3271; H04L 2209/80; H04L 9/3242; H04L 63/16; H04L 9/3247; H04L 63/0428; H04L 9/0841

(57) ABSTRACT

In an aspect of the disclosure, a method, a computer-readable medium, and an apparatus are provided. The apparatus may establish a communication link based on the 1905.1 protocol with at least one second AP. The apparatus may receive an authentication request from the at least one second AP via the communication link based on the 1905.1 protocol. In certain aspects, the authentication request may include at least a first signed certificate and a first generated value. The apparatus may transmit an authentication response to the at least one second AP using the communication link based on the 1905.1 protocol. In certain aspects, the authentication response may include at least a second signed certificate and a second generated value. The apparatus may determine shared information with the at least one second AP based at least in part on the first generated value and the second generated value.

### CROSS-REFERENCE TO RELATED APPLICATION(S)

This application claims the benefit of U.S. Provisional Application Ser. No. 62/476,663, entitled “EXCHANGING MESSAGE AUTHENTICATION CODES FOR ADDITIONAL SECURITY IN A COMMUNICATION SYSTEM” and filed on Mar. 24, 2017, which is expressly incorporated by reference herein in its entirety.

### BACKGROUND

### Field

The present disclosure relates generally to communication systems, and more particularly, to exchanging message authentication codes for additional security in a communication system.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

In an aspect of the disclosure, a method, a computer-readable medium, and an apparatus are provided. The apparatus may establish a communication link based on the 1905.1 protocol with at least one second AP. The apparatus may receive an authentication request from the at least one second AP via the communication link based on the 1905.1 protocol. In certain aspects, the authentication request may include at least a first signed certificate and a first generated value. The apparatus may transmit an authentication response to the at least one second AP using the communication link based on the 1905.1 protocol. In certain aspects, the authentication response may include at least a second signed certificate and a second generated value. The apparatus may determine shared information with the at least one second AP based at least in part on the first generated value and the second generated value.

In another aspect of the disclosure, the apparatus may establish a communication link based on the 1905.1 protocol with a second AP. The apparatus may transmit an authentication request to the second AP using the communication link based on the 1905.1 protocol. In certain aspects, the authentication request may include at least a first signed certificate and a first generated value. The apparatus may receive an authentication response from the second AP via the communication link based on the 1905.1 protocol. In certain aspects, the authentication response may include at least a second signed certificate and a second generated value. The apparatus may determine shared information with the second AP based at least in part on the first generated value and the second generated value.

### BRIEF DESCRIPTION OF THE DRAWINGS

FIG. 1A shows an example communication system in which aspects of the present disclosure may be employed.

FIG. 1B illustrates an example communication system in which devices may communicate using a 1905.1 protocol structure in accordance with certain aspects of the disclosure.

FIGS. 2A-2C are a diagram illustrating a data flow for a wireless or wired devices may communicate using a 1905.1 protocol structure in accordance with certain aspects of the present disclosure.

FIG. 2D is a diagram illustrating an 1905.1 authenticated encryption message in which a message authentication code (MAC) that is included in a MAC type length value (TLV) (MAC-TLV) follows an encrypted portion of the message in accordance with certain aspects of the disclosure.

FIG. 2E is a diagram illustrating an 1905.1 authenticated encryption message in which the MAC is included in a trailer of an authentication encryption (AE)-TLV (AE-TLV) accordance with certain aspects of the disclosure.

FIGS. 3A-3C are a diagram illustrating a data flow for a devices may communicate using a 1905.1 protocol structure in accordance with certain aspects of the present disclosure.

FIG. 4 shows an example functional block diagram of a wireless device that may communicate using a 1905.1 protocol structure in accordance with certain aspects of the present disclosure.

FIGS. 5A and 5B are a flowchart of an example method for wired or wireless communications using the 1905.1 protocol in accordance with certain aspects of the present disclosure.

FIG. 6 is a functional block diagram of an example communication device that may communicate using a 1905.1 protocol structure in accordance with certain aspects of the present disclosure.

FIG. 7 shows an example functional block diagram of a first device that may communicate using a 1905.1 protocol structure in accordance with certain aspects of the present disclosure.

FIGS. 8A and 8B are a flowchart of an example method for wired or wireless communications using the 1905.1 protocol in accordance with certain aspects of the present disclosure.

FIG. 9 is a functional block diagram of an example communication device that may communicate using a 1905.1 protocol structure in accordance with certain aspects of the present disclosure.

### DETAILED DESCRIPTION

Various aspects of the novel systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol, a wired protocol, and/or a 1905.1 protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In certain configurations, wireless and/or wired signals may be transmitted according to a 1905.1 protocol or a 1905.1 related protocol. A 1905.1 related protocol may include, e.g., a Multi-AP Technical Specification (e.g., version 180305). The 1905.1 protocol may support various media including, for example, Ethernet, Wi-Fi, powerline based on a 1901 protocol, and/or co-ax cabling using a Multimedia over Co-Ax (MoCA) protocol.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol, IEEE 1905.1 protocol, IEEE 1905.1-related protocol, etc.) compliant wireless link to obtain general connectivity to the Internet or to other wide area networks. In some implementations a STA may also be used as an AP.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard and/or 1905.1 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

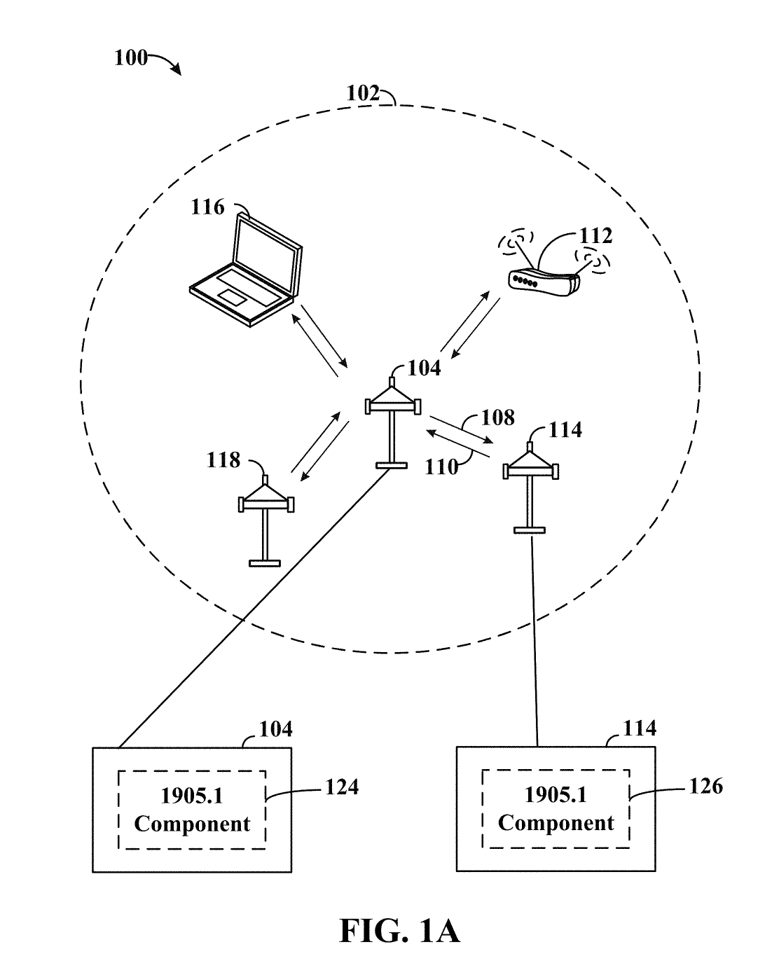

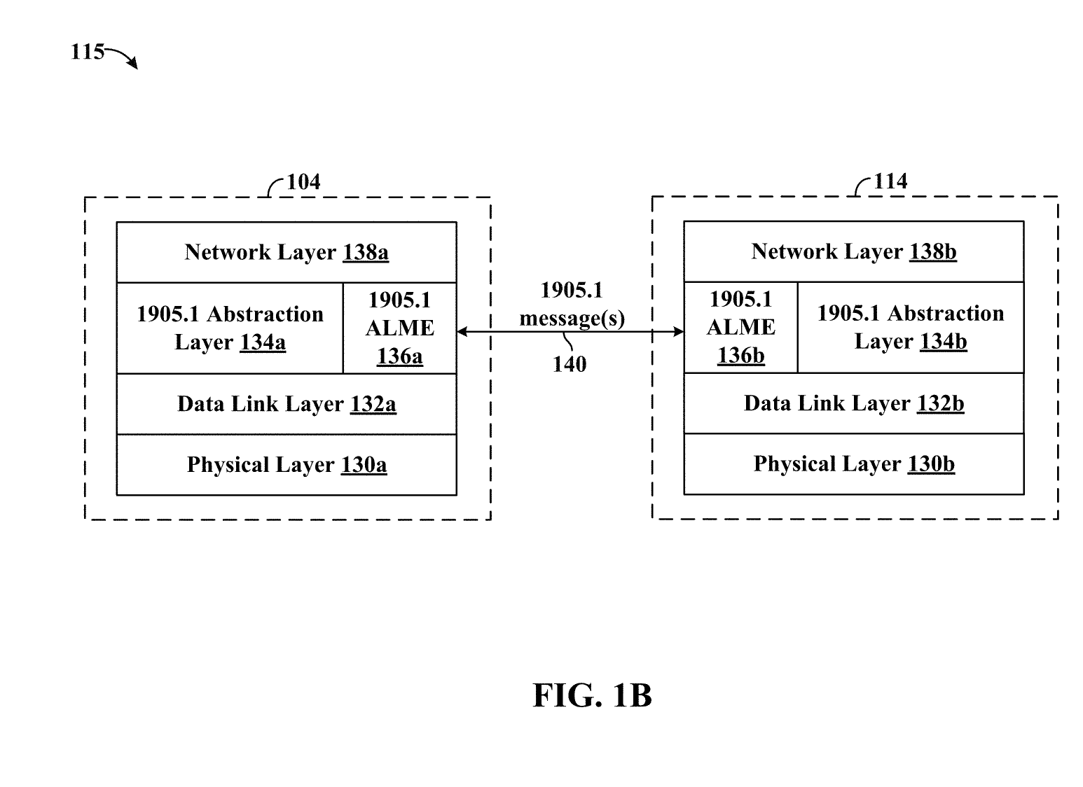

FIG. 1A shows an example communication system 100 in which aspects of the present disclosure may be employed. The communication system 100 may operate pursuant to a wireless standard (e.g., IEEE 802.11 standard, the IEEE 1905.1 protocol, etc.) or a wired standard (e.g., IEEE 1905.1 protocol, etc.). The communication system 100 may include an AP 104 (e.g., a root AP (RAP), which communicates with STAs (e.g., STAs 112, and 116) and other APs (e.g., satellite AP (SAP) 114 and SAP 118).

A variety of processes and methods may be used for transmissions in the communication system 100 between the AP 104 and the STAs. For example, signals may be sent and received between the AP 104 and the STAs in accordance with OFDM/OFDMA techniques. If this is the case, the communication system 100 may be referred to as an OFDM/OFDMA system. Alternatively, signals may be sent and received between the AP 104 and the STAs in accordance with CDMA techniques. If this is the case, the communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The APs 104, 114, 118 along with the STAs associated with the AP 104 and that use the AP 104 for communication may be referred to as a basic service set (BSS). It should be noted that the communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 116) may be required to associate with the AP 104 in order to send communications to and/or to receive communications from the AP 104. In one aspect, information for associating is included in a beacon broadcast by the AP 104. To receive such a beacon, the STA 116 may, for example, perform a broad coverage search over a coverage region. A search may also be performed by the STA 116 by sweeping a coverage region in a lighthouse fashion, for example. After receiving the information for associating, the STA 116 may transmit a reference signal, such as an association probe or request, to the AP 104. In some aspects, the AP 104 may use backhaul services, for example, to communicate with a larger network, such as the Internet or a public switched telephone network (PSTN).

In an aspect, the RAP 104 (e.g., first AP) may include one or more components for performing various functions. For example, the RAP 104 may include a 1905.1 component 124 to perform procedures related to exchanging messages with a group of APs (e.g., SAPs 114, 118, 204, 304a, 304b, 304c, the communication device 702, 900) using the 1905.1 protocol or 1905.1-related protocol. In certain configurations, the RAP 104 may include a multi-AP controller configured to control and/or communicate with a group of SAPs. In certain aspects, the 1905.1 component 124 may be configured to establish a communication link based on the 1905.1 protocol with at least one second AP. The 1905.1 component 124 may be configured to receive an authentication request from the at least one second AP via the communication link based on the 1905.1 protocol. In certain aspects, the authentication request may include at least a first signed certificate and a first generated value. The 1905.1 component 124 may be configured to determine if the at least one second AP is associated with a same certificate authority as the first AP based on a verification key and the first signed certificate. The 1905.1 component 124 may be configured to transmit an authentication response to the at least one second AP using the communication link based on the 1905.1 protocol. In certain aspects, the authentication response may include at least a second signed certificate and a second generated value. In certain other aspects, the authentication response may be transmitted when it is determined that the at least one second AP is associated with the same certificate authority as the first AP. In certain other aspects, the verification key may be a certificate authority digital signature. The 1905.1 component 124 may be configured to determine shared information with the at least one second AP based at least in part on the first generated value and the second generated value. In certain aspects, the shared information may be preconfigured at the first AP and the at least one second AP. The 1905.1 component 124 may be configured to determine a pairwise master key (PMK) based on the shared information. The 1905.1 component 124 may be configured to determine a Group Transient Key (GTK) and a key index associated with the GTK. The 1905.1 component 124 may be configured to determine a PTK when both the first AP and the at least one second AP use the PMK during the handshake communication.

The 1905.1 component 124 may be configured to determine a message authentication code (MAC) based at least in part on the GTK. The 1905.1 component 124 may be configured to transmit the GTK and the key index to at least one second AP. In certain aspects, the GTK and the key index may be encrypted using the PTK when transmitted to the at least one second AP.

The 1905.1 component 124 may be configured to transmit one or more messages to the at least one second AP using the communication link based on the 1905.1 protocol. In certain aspects, the MAC may be included in a MAC type length value (TLV) (MAC-TLV) portion of each of the one or more messages. The 1905.1 component 124 may be configured to determine a keyed-hash message authentication code (HMAC) for each of the one or more messages based at least in part on a message header and all type length values (TLVs) excluding the MAC-TLV. In certain aspects, each of the one or more messages may include an incremented value. The 1905.1 component 124 may be configured to determine a new GTK based on a value generated by, e.g., a cryptographically secure random number generator) when a timer expires at the first AP or when at least one of the second APs leaves a group associated with the GTK. The 1905.1 component 124 may be configured to transmit the new GTK and a new key index to the at least one second AP using the communication link based on the 1905.1 protocol. In certain aspects, the new GTK and the new key index may be encrypted. The 1905.1 component 124 may be configured to receive an acknowledgement indicating that the new GTK is received by the at least one second AP. In certain aspects, the acknowledgement may be received via the communication link based on the 1905.1 protocol. In certain other aspects, the new key index may be included in new messages when the acknowledgement is received.

In another aspect, the other AP 114 (e.g., SAP) may include one or more components for performing various functions. For example, an SAP 114 may include a 1905.1 component 126 to perform procedures related to exchanging messages with a second AP (e.g., RAP 104) using the 1905.1 protocol. In the example, the 1905.1 component 126 may be configured to establish a communication link based on the 1905.1 protocol with a second AP. The 1905.1 component 126 may be configured to transmit an authentication request to the second AP using the communication link based on the 1905.1 protocol. In certain aspects, the authentication request may include at least a first signed certificate and a first generated value. The 1905.1 component 126 may be configured to determine if the second AP is associated with a same certificate authority as the first AP based on a verification key and the second signed certificate. In certain aspects, the verification key may be a certificate authority digital signature associated with the same certificate authority. The 1905.1 component 126 may be configured to receive an authentication response from the second AP via the communication link based on the 1905.1 protocol. In certain aspects, the authentication response may include at least a second signed certificate and a second generated value. The 1905.1 component 126 may be configured to determine shared information with the second AP based at least in part on the first generated value and the second generated value. In certain aspects, the shared information may be preconfigured at the first AP and the second AP. The 1905.1 component 126 may be configured to determine a PMK based on the shared information with the at least one second AP. The 1905.1 component 126 may be configured to receive a GTK and a key index associated with the GTK from the second AP. The 1905.1 component 126 may be configured to determine a MAC based at least in part on one of the GTK or a pairwise transient key (PTK). The 1905.1 component 126 may be configured to receive one or more messages from the second AP via the communication link based on the 1905.1 protocol. In certain aspects, a MAC may be included in a MAC-TLV portion of each of the one or more messages. The 1905.1 component 126 may be configured to receive a new GTK and a new key index from second AP using the communication link based on the 1905.1 protocol upon the expiration of a timer or when a different access point leaves a multi-access point group associated with the first AP. In certain aspects, the new GTK and the new key index may be encrypted. The 1905.1 component 126 may be configured to transmit an acknowledgement indicating that the new GTK is received to the second AP. In certain aspects, the acknowledgement may be transmitted using the communication link based on the 1905.1 protocol. In certain other aspects, the new key index may be included in new messages when the acknowledgement is transmitted.

In a Wi-Fi network, wireless devices such as APs and STAs may perform a clear channel assessment (CCA) to determine whether a transmission channel is busy or idle for purposes of determining whether data may be transmitted to another wireless device. A CCA has two components: carriers sense (CS) and energy detection. Carrier sense refers to an ability of a wireless device (e.g., AP or STA) to detect and decode incoming Wi-Fi signal preambles, signals which enable the receiver to acquire a wireless signal from and synchronize with the transmitter, from other wireless devices. For example, a first AP may broadcast a Wi-Fi signal preamble, and the Wi-Fi signal preamble may be detected by a second AP or a STA. Similarly, a third AP may broadcast a Wi-Fi signal preamble, and the Wi-Fi signal preamble may be detected by the second AP. When the second AP detects one or more of the Wi-Fi signal preambles, the second AP may determine that the transmission channel is busy and not transmit data. The CCA may remain busy for the length of a transmission frame associated with the Wi-Fi signal preambles.

The second component of CCA is energy detection, which refers to the ability of a wireless device to detect an energy level present on a transmission channel. The energy level may be based on different interference sources, Wi-Fi transmissions, a noise floor, and/or ambient energy. Wi-Fi transmissions may include unidentifiable Wi-Fi transmissions that have been corrupted or are so weak that the transmission can no longer be decoded. Unlike carrier sense, in which the exact length of time for which a transmission channel is busy may be known, energy detection uses periodic sampling of a transmission channel to determine if the energy still exists. Additionally, energy detection may require at least one threshold used to determine whether the reported energy level is adequate to report the transmission channel as busy or idle. This energy level may be referred to as the ED level/ED threshold level or the CCA sensitivity level. For example, if an ED level is above a threshold, a wireless device may defer to other devices by refraining from transmitting.

FIG. 1B illustrates an example communication system 115 in which an RAP 104 and an SAP 114 may communicate using a 1905.1 protocol structure in accordance with certain aspects of the disclosure.

At each of the RAP 104 and the SAP 114, the 1905.1 protocol structure may include a corresponding physical layer 130a, 130b, a data link layer 132a, 132b, a 1905.1 abstraction layer 134a, 134b, a 1905.1 abstraction layer management entity (ALME) 136a, 136b, and a network layer 138a, 138b.

The physical layer 130a, 130b may include or be associated with the electronic circuit transmission technologies of a wireless or wired network. The physical layer 130a, 130b may be used to transmit a bit stream (e.g., raw bits) rather than logical data packets or messages over a physical data link connecting the RAP 104 and the SAP 114. The bit stream may be grouped into code words or symbols and converted to a physical signal that is transmitted over a transmission medium. The physical layer 130a, 130b may provide an electrical, mechanical, and/or procedural interface to the transmission medium. The shapes and properties of the electrical connectors, the frequencies to broadcast on, the line code to use and similar low-level parameters, may be specified by the physical layer 130a, 130b.

The data link layer 132a, 132b may be used to transfer data packets and/or messages between the RAP 104 and the SAP 114. Additionally and/or alternatively, the data link layer 132a, 132b may be used to detect and possibly correct errors that may occur in the physical layer.

IEEE 1905.1 is an IEEE standard which defines a network enabler for home networking supporting both wireless and wired technologies: IEEE 802.11 (e.g., Wi-Fi®), IEEE 1901 (e.g., HomePlug, high definition powerline communication (HD-PLC), etc.) powerline networking, IEEE 802.3 Ethernet and Multimedia over Coax (MoCA), just to name a few. The abstraction layer 134a, 134b 1905.1 devices that hides the diversity of the different media access control technologies. The abstraction layer 134a, 134b may exchange 1905.1 messages 140 (e.g., Control Message Data Units (CMDUs)) with 1905.1 configured devices.

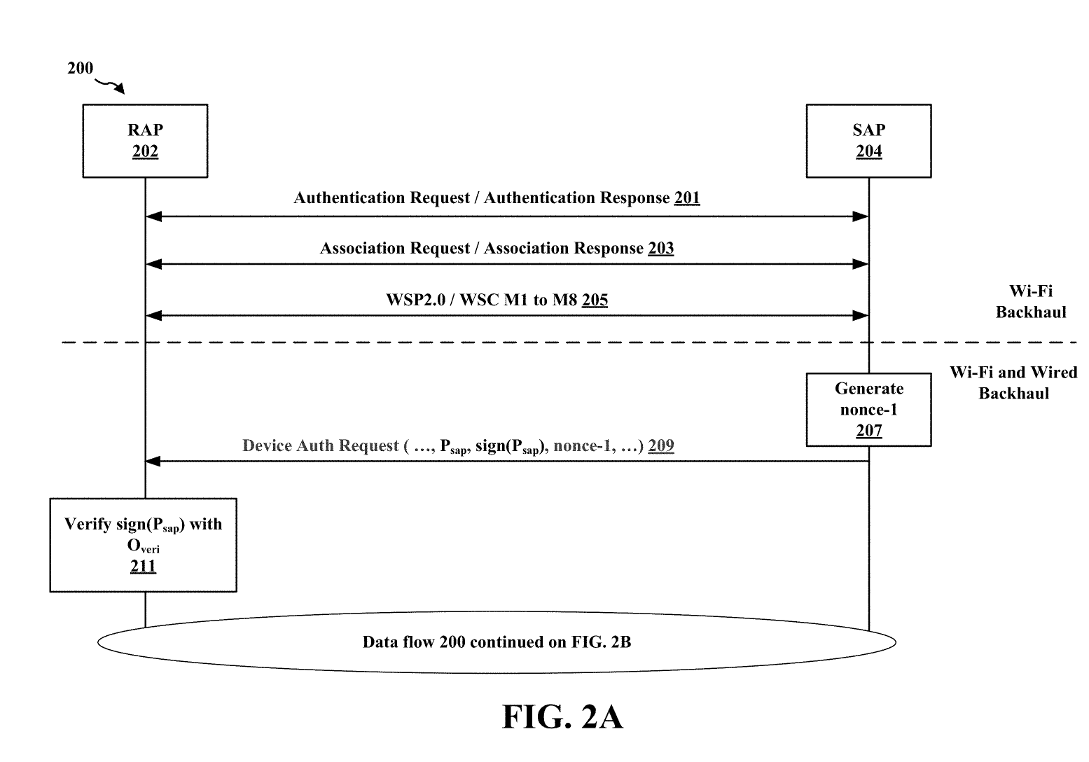

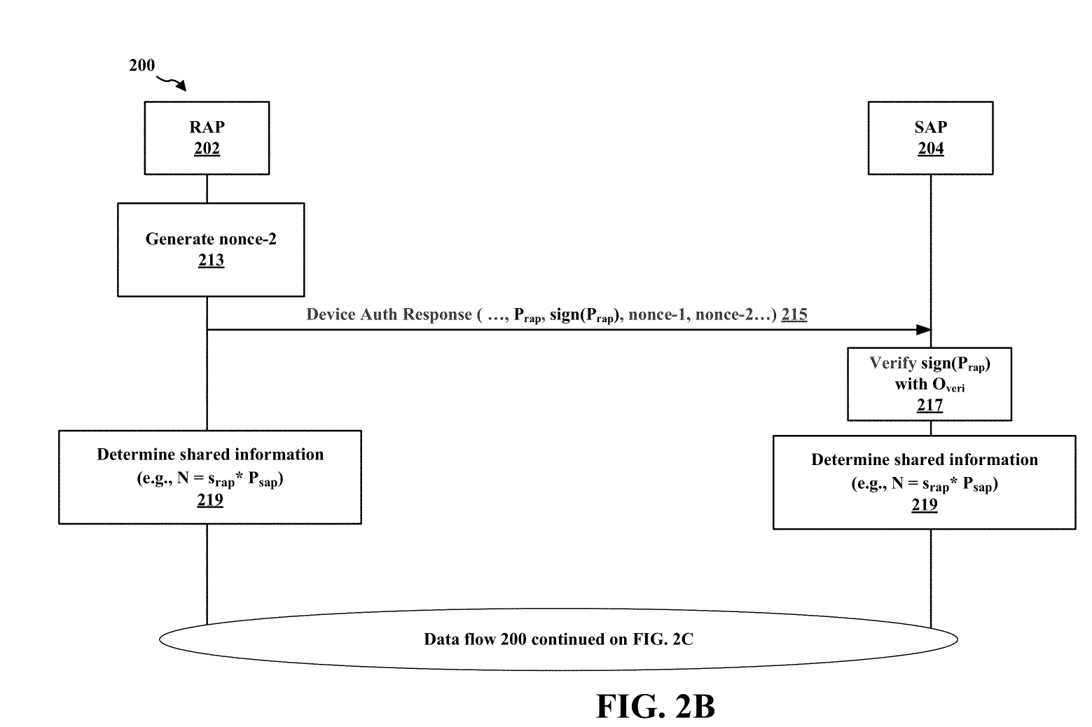

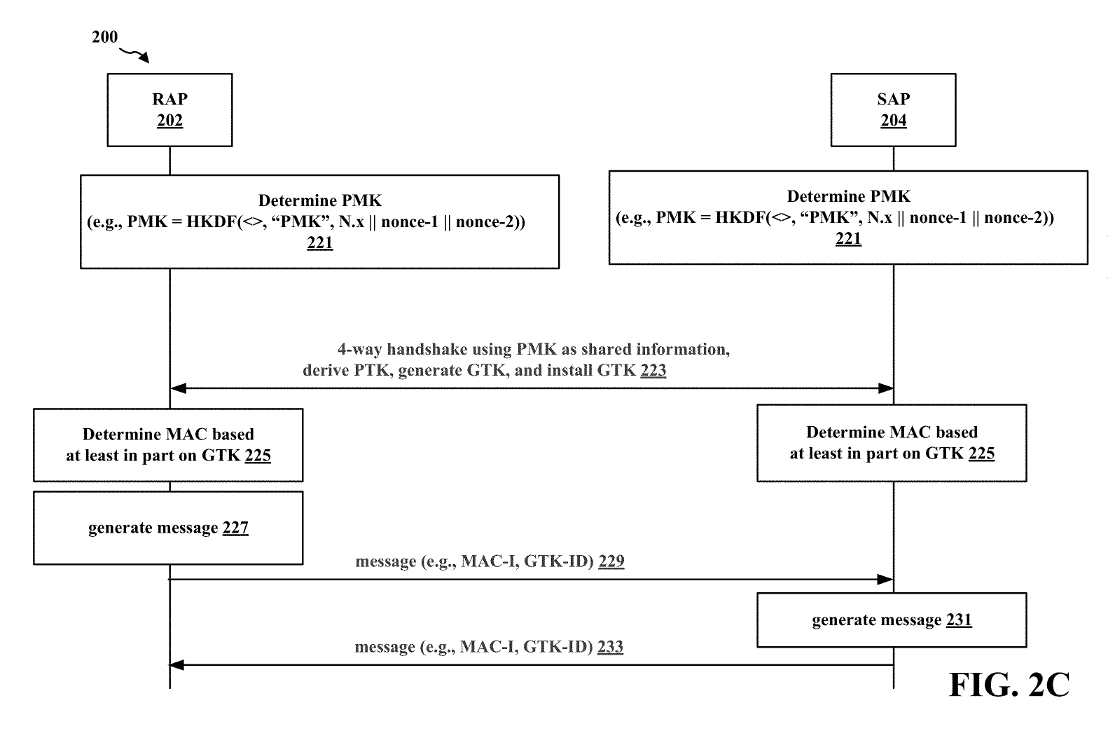

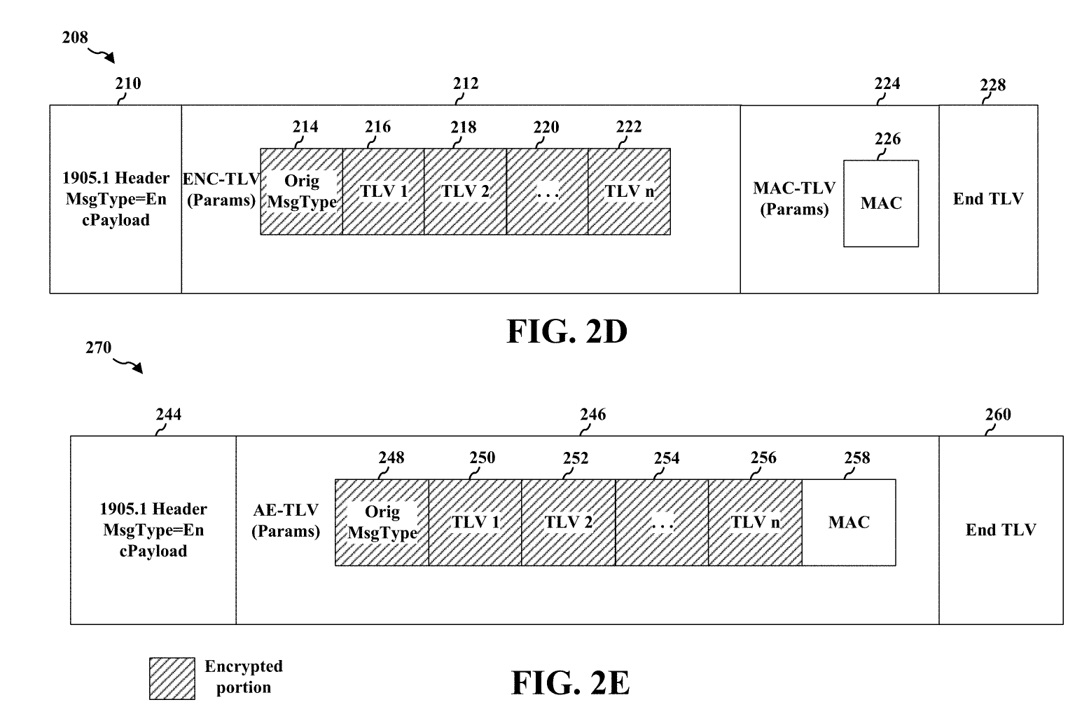

The abstraction layer management entity (ALME) 136a, 136b may include a management entity supporting different media dependent management entities and a flow-based forwarding table. The 1905.1 protocol may be used between the ALMEs 136a, 136b to distribute different types of 1905.1 messages 140, e.g., as described below in connection with any of FIGS. 2A-9.

The network layer 138a, 138b may transfer network packets from the RAP 104 to the SAP 114, and vice versa, via one or more networks. The network layer 138a, 138b may issue service requests to the data link layer 132a, 132b.

As mentioned above, wireless and/or wired signals may be transmitted according to a 1905.1 protocol. The 1905.1 protocol may support various media including, for example, Ethernet, Wi-Fi, powerline based on a 1901 protocol, and/or co-ax cabling using a MoCA protocol. While transmitting signals using the 1905.1 protocol may provide flexibility by supporting various media, the 1905.1 protocol may be inherently insecure because an 1905.1 enabled AP may not be able to distinguish between a 1905.1 authorized device and a non-1905.1 authorized device. Hence, a potential attacker may abuse the flexibility of the 1905.1 protocol by using non-1905.1 authorized devices connected to the Wi-Fi network to send arbitrary 1905.1 messages and trigger 1905.1 unauthorized actions by 1905.1 authorized devices within the network because a 1905.1 authorized device may not be able to determine that the arbitrary 1905.1 messages are sent by a non-1905.1 authorized device.

The present disclosure provides a solution by providing an authentication process using the 1905.1 protocol in order to determine that each device is a 1905.1 authorized device before messages are communicated therebetween. In addition, the present disclosure provides a solution by providing anti-replay mechanisms for 1905.1 control messages such that: 1) only securely provisioned APs may exchange 1905.1 control messages, 2) replayed messages by a malicious device may be ignored by a 1905.1 authorized device, and 3) injected messages by a malicious device may be ignored by a 1905.1 authorized device.

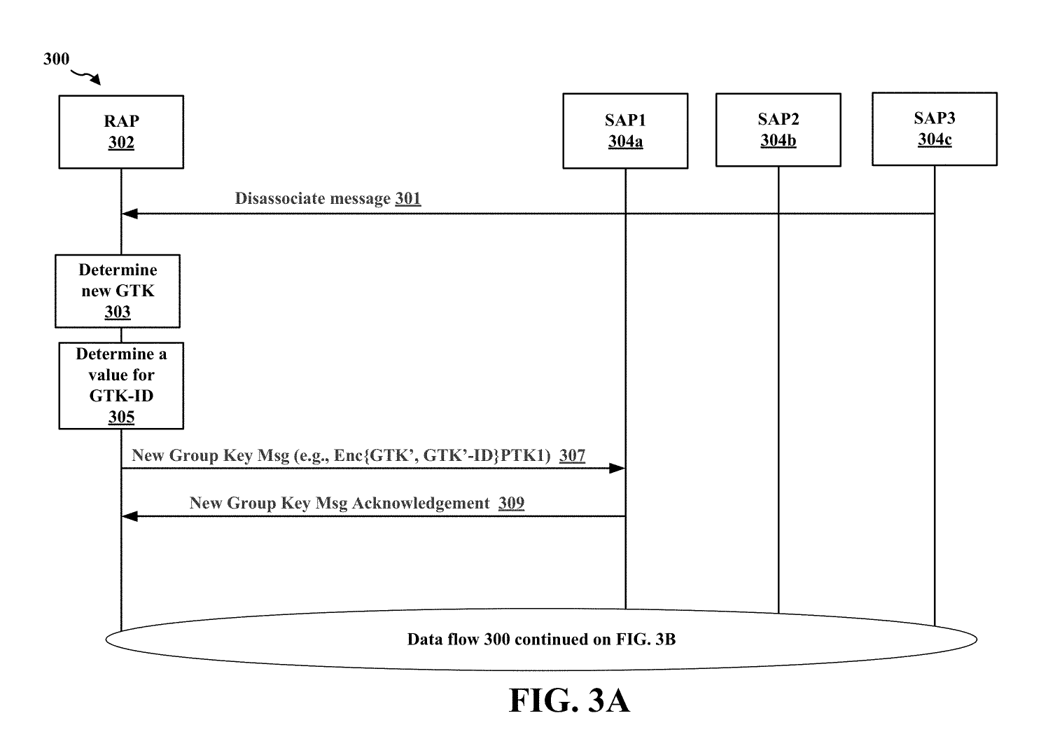

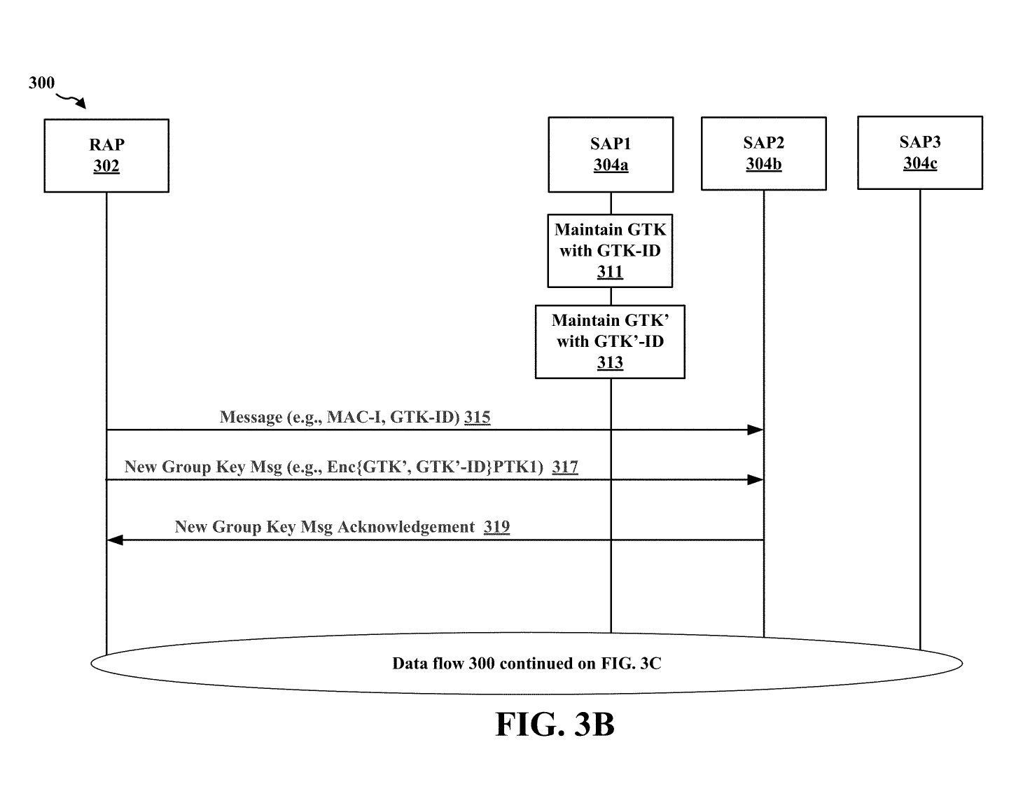

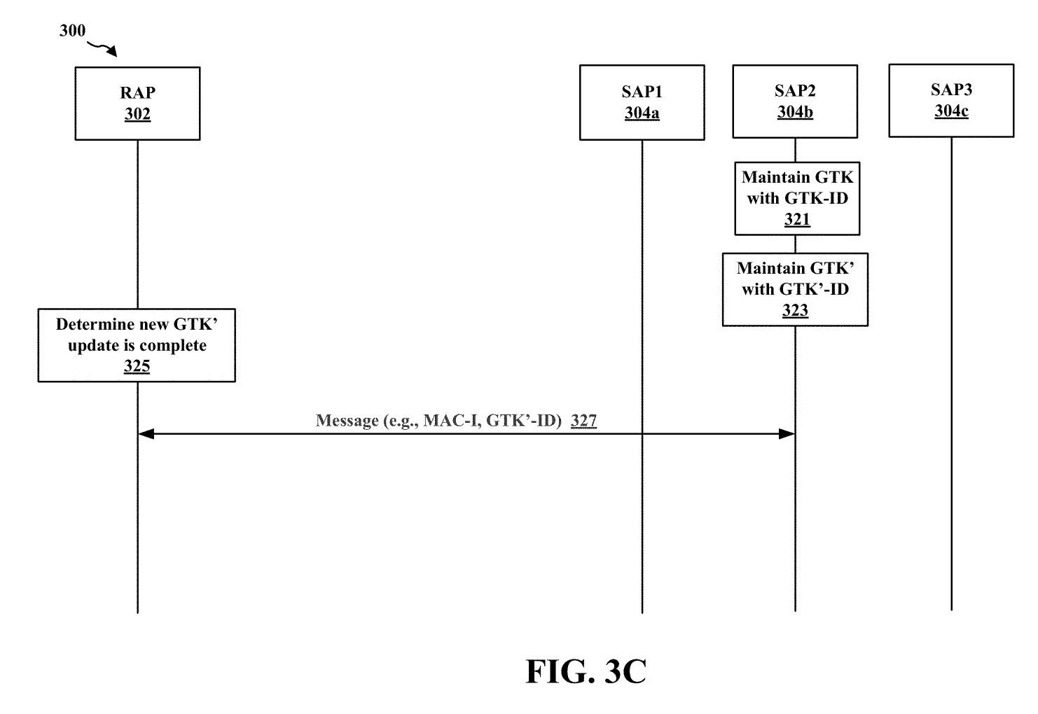

Various aspects are described below with respect to FIGS. 2A-2C and 3A-3C. The aspects of the present disclosure may be compatible with future developments of the 1905.1 protocol for secure onboarding, and may be compatible with a Wi-Fi device provisioning protocol (DPP). If the Wi-Fi protected setup (WPS)2.0 (WPS2.0) described below with respect to FIG. 2A is replaced with DPP bootstrapping and authentication, then the signed public key and verification key may be dynamically generated and provisioned to the RAP and/or SAPs by the configurator in the form of DPP configuration objects. Then the DPP network access protocol may exchange the configuration objects and establish the shared key, to start WPA2.0 and/or WPA3.0 personal and grant secure Wi-Fi network access.

Although the following description of MAC exchange and anti-replay mechanisms are described with respect to the 1905.1 protocol, the MAC exchange and anti-replay mechanisms detailed below may apply to a 1905.1 related wireless or wired protocol without departing from the scope of the present disclosure.

FIGS. 2A-2C illustrate a data flow 200 that may enable an RAP 202 and an SAP 204 to determine that each device is a 1905.1 authorized device prior to exchanging messages after a 1905.1 communication link is established in accordance with certain aspects of the disclosure. The RAP 202 may correspond to, e.g., AP 104, RAP 302, communication device 402, communication device 600. The SAP 204 may correspond to, e.g., AP 114, 118, SAP1 304a, SAP2 304b, SAP3 304c, communication device 702, 900. In addition, the RAP 202 and the SAP 204 may be configured to communicate using the 1905.1 protocol, or any other wireless or wired protocol. In a non-limiting example, the RAP 202 and the SAP 204 may each be 1905.1 authorized devices.

Further, each of the RAP 202 and the SAP 204 may be pre-provisioned by a certificate authority (e.g., an operator) with various cryptographic information that may be used for sending messages between the RAP 202 and the SAP 204. For example, each of the RAP 202 and the SAP 204 may be pre-configured with a pair of authenticated keys (e.g., public key, private key, etc.) provided by the certificate authority.

In certain configurations, the public key cryptography may employ elliptic curves, e.g., National Institute of Science and Technology (NIST) curve p-256. Open secure sockets layer (SSL) (OpenSSL) cryptology may provide two command line tools for working with keys suitable for elliptic curve algorithms. The elliptic curve algorithms supported by OpenSSL may include Elliptic Curve Diffie Hellman (ECDH) for key agreement and Elliptic Curve Digital Signature Algorithm (ECDSA) for signing/verifying. Hence, the key agreement and digital signatures used by the RAP 202 and/or the SAP 204 may be ECDH and ECDSA, respectively.

In certain aspects, the authenticated public key pre-configured at the RAP 202 may be Pᵣₐₚ and the private key preconfigured at the RAP 202 may be sᵣₐₚ. In certain other aspects, the private key preconfigured at the SAP 204 may be sₛₐₚ, and the authenticated public key preconfigured at the SAP 204 may be Pₛₐₚ. Each of the public keys may be digitally signed with the certification authority signing key O_{sign}, which the certificate authority keeps secret, whereas the digital signature, e.g., sign(Pᵣₐₚ), and the verification key, Oᵥₑᵣᵢ, may be preconfigured at the RAP 202 and the SAP 204. In other words, the RAP 202 may be preconfigured with (sᵣₐₚ, Pᵣₐₚ), sign(Pᵣₐₚ) and Oᵥₑᵣᵢ, and the SAP 204 may be preconfigured with (sₛₐₚ, Pₛₐₚ), sign(Pₛₐₚ) and Oᵥₑᵣᵢ.

Referring to FIG. 2A, the RAP 202 and the SAP 204 may perform an association procedure 201, 203, 205 to establish a communication link (e.g., media access) when, for example, a user presses a push button located on one or more of the RAP 202 and/or the SAP 204. In one aspect, the association procedure 201, 203, 205 may follow a WPS2.0 procedure and/or a programmable logic controller (PLC) procedure. In another aspect, the association procedure may include communicating one or more authentication requests/authentication responses 201 between the RAP 202 and the SAP 204. In a further aspect, the association procedure may include communicating one or more association requests/association responses 203 between the RAP 202 and the SAP 204. Additionally, the RAP 202 and the SAP 204 may perform a WPS 2.0 procedure 205 and/or a Wi-Fi simple configuration (WSC) protocol 205, e.g., by exchanging messages M1 to M8. In one aspect, the association procedure 201, 203, 205 may be performed using a Wi-Fi backhaul link, while the following description of the data flow 200 may be performed using the Wi-Fi backhaul link and/or Wired backhaul link.

Once the association procedure 201, 203, 205 is complete and the 1905.1 communication link is established, the SAP 204 may generate a first generated value (e.g., nonce-1) 207. Further, the SAP 204 may transmit a device authentication request 209 that includes one or more of public credentials (e.g., Pₛₐₚ, sign(Pₛₐₚ), nonce-1, etc.) to the RAP 202. The RAP 202 may verify 211 and/or determine 211 the credentials (e.g., sign(Pₛₐₚ)) of the SAP 204 using the verification key (e.g., Oᵥₑᵣᵢ) in order to determine if the SAP 204 is associated with the same certificate authority as the RAP 202.

Referring to FIG. 2B, the RAP 202 may generate a second generated value (e.g., nonce-2) 213. Further, the RAP 202 may transmit a device authentication response 215 that includes one or more of public credentials (e.g., Pᵣₐₚ, sign(Pᵣₐₚ), nonce-1, nonce-2, etc.) to the SAP 204 when the RAP 202 verifies 211 and/or determines 211 that the SAP 204 is associated with the same certificate authority as the RAP 202. The SAP 204 may verify 217 the credentials (e.g., sign(Pᵣₐₚ)) of the SAP 204 using the verification key (e.g., Oᵥₑᵣᵢ) of the certificate authority that is preconfigured at the SAP 204.

Each of the RAP 202 and the SAP 204 may determine shared information 219 (e.g., a shared secret N) using one or more of an ECDH, a private key (e.g., sₛₐₚ and/or sᵣₐₚ), a public key (e.g., Pₛₐₚ and/or Pᵣₐₚ), the first generated value (e.g., nonce-1), and/or the second generated value (e.g., nonce-2) when the credentials of the other device are verified. In certain configurations, the shared information 219 may be used to derive one or more keys (e.g., PMK, GTK, etc.) that may be used to generate one or more MACs. In one aspect, the PMK, GTK (e.g., randomly generated using a cryptographically secure pseudorandom number generator), and/or value generated by a cryptographically secure number generator discussed below may be derived and/or determined from the shared information 219 using a keyed-hash message authentication code (HMAC)-based Extract-and-Expand Key Derivation Function (HKDF) with a hash function (e.g., SHA256, etc.). Additionally, the shared information 219 can be used for various purposes, e.g., initiate WPA2.0 procedures to derive additional shared information and/or group secrets for further use in the data flow 200.

Referring to FIG. 2C, each of the RAP 202 and the SAP 204 may determine a PMK 221.

In a first example, the PMK 221 may be determined using one or more of a HKDF, the shared information 219 (e.g., N.x), the first generated value (e.g., nonce-1), and/or the second generated value (e.g., nonce-2).

In a second example, the PMK 221 may be determined using public key agreement protocols and/or using the public key credentials preconfigured at the RAP 202 and SAP 204 followed by 4-way handshake procedure.

In a third example, the PMK 221 may be determined based on a preconfigured symmetric key. The preconfigured symmetric key may be set to PMK and the 4-way handshake may be executed. The third example may provide less security than the first example and/or the second example, because each of the RAP 202 and the SAP 204 may be preconfigured with the same shared secret.

In a fourth example, in instances of the extended authentication framework, i.e., Wi-Fi Simple Configuration (e.g., for use over the Wi-Fi backhaul channel), the RAP 202 and the SAP 204 may determine a pairwise secret; expand the pairwise secret using a pseudo-random function to a random number and set it to PMK (e.g., the seed to the pseudo-random function may be nonce-1, nonce-2, different nonces, and/or media access control address(es)). The RAP 202 and the SAP 204 may then perform the 4-way handshake. In certain aspects, the fourth example may provide additional security if the expansion of the determined pairwise secret has increased complexity as compared to the shared secrets described above in connection with the first example, the second example, and the third example. However, in certain other aspects, the fourth example may provide less security than the first, second, and/or third example described above because a pseudo-random function may be used instead of a HKDF to derive the PMK, and nonces may be intercepted as well as the media access control addresses by an eavesdropper.

The PMK is designed to last as long as the 1905.1 communication link is maintained, and hence, should be exposed as little as possible. Consequently, the RAP 202 and the SAP 204 may derive keys to encrypt and/or integrity protect messages communicated using the 1905.1 communication link so that the PMK need not be used to protect messages sent over the 1905.1 communication link. In certain configurations, a four-way handshake may be performed to generate another key called the PTK. Using the PMK 221 as additional shared information, the RAP 202 and the SAP 204 may perform a four-way handshake 223 to derive the PTK, install GTK (e.g., using the cryptographically secure pseudorandom number generator) at the SAP 204, assign the GTK an index (e.g., the first GTK may be assigned index 0, and the second GTK may be assigned index 1, etc.).

The four-way handshake is designed so that the RAP 202 and SAP 204 may independently prove to each other that they know the PMK, without ever disclosing the key. Instead of disclosing the key, the RAP 202 and the SAP 204 may encrypt or integrity protect messages to each other that can only be decrypted or integrity verified by using the PMK that they already share, and if decryption or integrity verification of the messages was successful, this proves knowledge of the PMK. The four-way handshake may be useful for protection of the PMK from malicious APs (e.g., 1905.1 unauthorized device), e.g., an attacker's network name (SSID) impersonating a 1905.1 authorized device so that the RAP 202 never has to provide an SAP with its PMK.

The PMK is designed to last the entire session and should be exposed as little as possible. Therefore, keys such as the PTK that are used to encrypt the traffic may be derived.

In certain aspects, the PTK may be generated by concatenating one or more of the PMK, the first generated value (e.g., nonce-1), the second generated value (e.g., nonce-2), the RAP's 202 media access control address, and/or the SAP's 204 media access control address. The result of the concatenation may then be put through a pseudo-random function to generate the PTK. The handshake also yields the GTK (Group Temporal Key), used to decrypt multicast and broadcast traffic.

The messages exchanged during the four-way handshake may include: 1) a first message that includes an RAP nonce value that is transmitted from the RAP 202 to the SAP 204 (e.g., using the RAP nonce value the SAP 204 has all the attributes to construct the PTK), 2) a second message that includes an SAP nonce value and a message integrity check code (MIC) may be sent from the SAP 204 to the RAP 202, 3) the RAP 202 may generate and transmit the GTK and the GTK-ID with another MIC in a third message to the SAP 204, and 4) the SAP 204 may send a fourth message that acknowledges receipt of the third message that included the GTK and the GTK-ID.

In addition, one or more of the RAP 202 and/or the SAP 204 may determine a MAC 225 based on, e.g., the GTK or the PTK. In certain aspects, the GTK may be used to determine the MAC when transmitting a message to multiple SAPs, and the PTK may be used to determine the MAC when transmitting a message to a single SAP. The MAC may be included in a MAC-TLV portion of a 1905.1 message that is used to authenticate the message by the receiving AP. For example, the information included in the MAC-TLV may be used to determine whether the message was corrupted during transmission.

The RAP 202 may generate a message 227 for transmission to the SAP 204. In certain implementations, the generated message 227 may be a 1905.1 authenticated message that includes a 1905.1 header that indicates the message type (e.g., a 1905.1 integrity protected message, a 1905.1 encrypted message, etc.), a plurality of TLVs, a MAC-TLV, and an end TLV, as described below in connection with FIG. 2D.

One or more messages 229 may be transmitted from the RAP 202 to the SAP 204 that include the MAC, the PTK index or PTK-ID, and/or the GTK-index (ID)). Further, one or more messages 233 may be transmitted from the SAP 204 to the RAP 202 that include the MAC, the PTK, and/or the GTK-ID. By including the MAC (e.g., HMAC-SHA 256) in each of the one or more messages 229, 233 (e.g., the MAC may be included in a MAC-TLV portion of each of the one or more messages 229, 233), the authenticity and/or security of the messages 229, 233 may be increased. Furthermore, each message 229, 233 that is exchanged between the RAP 202 and the SAP 204 may include an incremented number to help ensure anti-replay.

In certain other implementations, the RAP 202 and the SAP 204 may perform an encryption key and derivation procedure, and the RAP 202 may generate 227 a 1905.1 encrypted message and/or a 1905.1 authenticated encryption message that includes encrypted TLVs and optionally a MAC-TLV (e.g., when the message is a 1905.1 authenticated encryption message), as described below in connection with FIGS. 2D and 2E. In order to generate the message 227, the RAP 202 may change the message type in the 1905.1 header to a special value to indicate the message is an encrypted message. If the message exceeds a certain number of bytes (e.g., 1500 bytes), the RAP 202 may identify the boundaries for message fragmentation (if any) such that there is sufficient space to encapsulate the TLVs in each fragment in a single encrypted (ENC)-TLV portion including any padding needed by the encryption scheme. The RAP 202 may prepend the original message type to the TLV plaintext to be encrypted, and encrypt all of the TLVs to obtain the ciphertext with TLV boundaries preserved and an authentication tag. The RAP 202 may then transmit each fragment of the message 229 with an appropriate 1905.1 header (e.g., in accordance with the 1905.1 protocol) with the final fragment containing a MAC-TLV and an End-TLV.

Upon receipt of the transmitted message 229, the SAP 204 may perform reassembly of the message fragmentation using the 1905.1 protocol, with the following modification. The SAP 204 may consolidate all ENC-TLVs into a single ENC-TLV, stripping off the Type and Length fields, perform the decryption to obtain the plaintext, verify the MAC-TLV if the message is an authenticated encryption message, update the message type field with the first byte of the plaintext, and pass the decrypted message (with the original TLVs) up the 1905.1 protocol stack for processing.

The SAP 204 may generate an encrypted and/or authenticated message 231 using similar techniques as described above for the RAP 202, and the RAP 202 may perform reassembly of the message fragmentation using similar techniques as described for the SAP 204.

Using one of the message structures illustrated in FIG. 2D or FIG. 2E, a 1905.1 device that does not implement the Multi-AP Technical Specification may still be able to forward relayed multicast frames even if they contain an encrypted payload, may be able to discard a message sent with encryption as unhandled without any erroneous processing, and may be provided with authenticated encryption message.

FIG. 2D is a diagram illustrating a 1905.1 authenticated encryption message 208 in accordance with certain aspects of the disclosure.

The 1905.1 authenticated encryption message 208 may include a 1905.1 header 210 that is set to a new message type (e.g., MsgType=EncPayload) that indicates the message contains an ENC TLV portion 212 (e.g., ENC-TLV and parameters) with a plurality of encrypted TLVs 214, 216, 218, 220, 222. To ensure existing 1905.1 devices do not try to look for specific TLVs that they will not find (e.g., and hence discard the messages), the message type in the header 210 is set to a new message type that indicates the message contains an encrypted payload. Everything in the ENC-TLV portion 212 other than the normal Type and Length fields (not shown) along with the encryption parameters are encrypted.

When the 1905.1 message is also authenticated as in the example in FIG. 2D, the 1905.1 authenticated encryption message 208 also includes a MAC-TLV portion 224 that includes parameters and the MAC 226 (e.g., authentication information for the message). The message may also include an end-TLV portion 228 that indicates to the receiving device that there are no additional TLVs to be received.

FIG. 2E is a diagram illustrating a 1905.1 authenticated encryption message 270 in accordance with certain aspects of the disclosure. The 1905.1 authenticated encryption message 270 may include a 1905.1 header 230 that is set to a new message type (e.g., MsgType=EncPayload) that indicates the message contains an authenticated and encrypted (AE) TLV (AE-TLV) portion 246 (e.g., AE-TLV and parameters) with an AE-TLV container 248 and a plurality of encrypted TLVs 250, 252, 254, 256 and the MAC-TLV 258. The parameters (Params) field in the AE-TLV portion 246 may include information (e.g., the encryption key index and any other information needed such as a sequence number and/or IV) that may be used by the receiver to properly decrypt the encrypted TLVs). Everything in the AE-TLV portion 246 other than the normal Type and Length fields (not shown) and the MAC 258 along with the encryption parameters are encrypted.

When the 1905.1 message is also authenticated as in the example in FIG. 2E, the AE-TLV portion 246 also includes a MAC 258 that includes the authentication information for the message. The message may also include an end-TLV portion 260 that indicates to the receiving device that the entire payload has been received.

FIGS. 3A-3C illustrate a data flow 300 for an RAP 302, a first SAP 304a (e.g., SAP1 304a), a second SAP 304b (e.g., SAP2 304b), and a third SAP 304c (e.g., SAP3 304c) to determine a new GTK (e.g., GTK′) when one of the SAPs 304a, 304b, 304c leaves the network in accordance with certain aspects of the disclosure. The RAP 302 may correspond to, e.g., AP 104, the RAP 202, communication device 402, 600. Each of the SAPs 304a, 304b, 304c may correspond to, e.g., AP 114, 118, the SAP 204, communication device 702, 900. In addition, the RAP 302 and the SAPs 304a, 304b, 304c may be configured to communicate using the 1905.1 protocol, or any other wireless or wired protocol. In a non-limiting example, the RAP 302 and the SAPs 304a, 304b, 304c may each be 1905.1 authorized devices that communicate messages that include one or more of a MAC, GTK, and/or GTK-ID as described above in the data flow 200 of FIGS. 2A-2C.

Referring to FIG. 3A, SAP3 304c may send a disassociate message 301 to the RAP 302. The disassociate message 301 may indicate that the SAP3 304c is leaving the network and will no longer be communicating with the RAP 302 (e.g., at least temporarily).

Upon receipt of the disassociate message 301, the RAP 302 may determine a new GTK 303 (e.g., GTK′ 303). In addition, the RAP 302 may determine a new GTK-ID′ 305 associated with the new GTK′. Each time that a SAP “leaves” the network (e.g., disassociates from the RAP 302), the RAP 302 may determine a new GTK′ and distribute the new GTK′ to the SAPs remaining in the group. Additionally and/or alternatively, the RAP 302 may determine a new GTK′ at the expiration of a timer (e.g., ≥3600 sec).

In one aspect, the RAP 302 may send a new group key message 307 that includes the new GTK′ 303 and the new GTK′-ID 305, and the message 307 may be encrypted using the PTK (e.g., either previously determined or a new PTK) to SAP 304a. SAP1 304a may respond with a new group key message acknowledgement 309 indicating that the new group key message 307 was received. Further, the SAP1 304a may maintain 311 the previous GTK with the GTK-ID until a message is received from the RAP 302 that the new GTK′-ID 305. In addition, the SAP1 304a may maintain the new GTK′ 303 with the new GTK′-ID 305 in order to authenticate a new message that uses the new GTK′ 303 with the new GTK′-ID 305 as being non-malicious. In other words, the SAP1 304a may temporarily maintain the previous GTK and the new GTK′ 303 at different indexes.

The RAP 302 may send one or more messages 315 to the SAP2 304b with the previous GTK-ID until the new group key procedure described above is complete. For example, the RAP 302 may send a new group key message 317 to SAP2 304b. The new group key message 317 may include the new GTK′ 303 and the new GTK′-ID 305, and the new group key message 317 may be encrypted with the PTK (e.g., either previously determined or a new PTK). SAP2 304b may respond with a new group key message acknowledgement 319 indicating that the new group key message 317 was received.

Referring to FIG. 3C, the SAP2 304b may maintain 321 the previous GTK with the GTK-ID until a message is received from the RAP 302 that includes the new GTK′-ID 305. In addition, the SAP2 304b may maintain the new GTK′ 303 with the new GTK′-ID 305 in order to recognize a new message that uses the new GTK′ 303 and the new GTK′-ID 305 as being non-malicious. In other words, the SAP2 304b may temporarily maintain the previous GTK and the new GTK′ at different indexes.

Once the RAP 302 receives new group key message acknowledgements 309, 319 from all remaining SAPs 304a, 304b in the group, the RAP 302 may determine 325 that the new GTK′ update is complete. Once the GTK′ update is complete, the RAP 302 and/or the SAPs 304a, 304b may begin communications 327 by sending and receiving messages 327 including the MAC, and the new GTK′-ID 305. The SAPs 304a, 304b may begin using the new GTK′ to integrity protect outgoing messages after the RAP 302 begins using the new GTK′ in outgoing messages (e.g., messages received by SAP1 304a or SAP2 304b) or after the RAP 302 determines the new GTK′ update is complete.

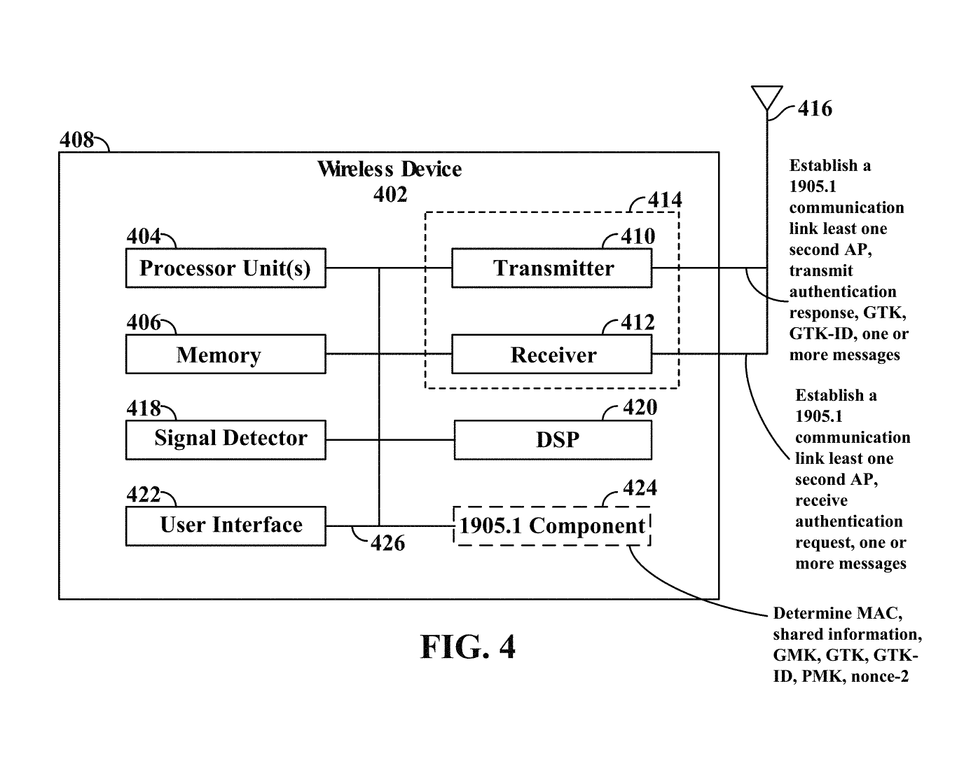

FIG. 4 shows an example functional block diagram of a communication device 402 that may exchange a MAC with a second device within the communication system 100 of FIG. 1A. The communication device 402 is an example of a device that may be configured to implement the various methods described herein. For example, the communication device 402 may comprise an AP (e.g., the AP 104, RAP 202, RAP 302).

The communication device 402 may include a processor 404 which controls operation of the communication device 402. The processor 404 may also be referred to as a central processing unit (CPU). Memory 406, which may include both read-only memory (ROM) and random access memory (RAM), may provide instructions and data to the processor 404. A portion of the memory 406 may also include non-volatile random access memory (NVRAM). The processor 404 typically performs logical and arithmetic operations based on program instructions stored within the memory 406. The instructions in the memory 406 may be executable (by the processor 404, for example) to implement the methods described herein.

The processor 404 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The communication device 402 may also include a housing 408, and the communication device 402 may include a transmitter 410 and/or a receiver 412 to allow transmission and reception of data between the communication device 402 and a remote device. The transmitter 410 and the receiver 412 may be combined into a transceiver 414. An antenna 416 may be attached to the housing 408 and electrically coupled to the transceiver 414. The communication device 402 may also include multiple transmitters, multiple receivers, multiple transceivers, and/or multiple antennas.

The communication device 402 may also include a signal detector 418 that may be used to detect and quantify the level of signals received by the transceiver 414 or the receiver 412. The signal detector 418 may detect such signals as total energy, energy per subcarrier per symbol, power spectral density, and other signals. The communication device 402 may also include a DSP 420 for use in processing signals. The DSP 420 may be configured to generate a packet for transmission. In some aspects, the packet may comprise a physical layer convergence procedure (PLCP) protocol data unit (PPDU).

The communication device 402 may further comprise a user interface 422 in some aspects. The user interface 422 may comprise a keypad, a microphone, a speaker, and/or a display. The user interface 422 may include any element or component that conveys information to a user of the communication device 402 and/or receives input from the user.

When the communication device 402 is implemented as an AP (e.g., the AP 104, RAP 202, RAP 302), the communication device 402 may also comprise a 1905.1 component 424. In an aspect, the communication device 402 (e.g., first AP) may include one or more components for performing various functions. For example, the communication device 402 may include a 1905.1 component 424 to perform procedures related to exchanging messages with a group of APs (e.g., SAPs 114, 118, 204, 304a, 304b, 304c, the communication device 702, 900) using the 1905.1 protocol or 1905.1-related protocol. The communication device 402 may include a multi-AP controller. In the example, the 1905.1 component 424 may be configured to establish a communication link based on the 1905.1 protocol with at least one second AP. The 1905.1 component 424 may be configured to receive an authentication request from the at least one second AP via the communication link based on the 1905.1 protocol. In certain aspects, the authentication request may include at least a first signed certificate and a first generated value. The 1905.1 component 424 may be configured to determine if the at least one second AP is associated with a same certificate authority as the first AP based on a verification key and the first signed certificate. The 1905.1 component 424 may be configured to transmit an authentication response to the at least one second AP using the communication link based on the 1905.1 protocol. In certain aspects, the authentication response may include at least a second signed certificate and a second generated value. In certain other aspects, the authentication response may be transmitted when it is determined that the at least one second AP is associated with the same certificate authority as the first AP. In certain other aspects, the verification key may be a certificate authority digital signature. The 1905.1 component 424 may be configured to determine shared information with the at least one second AP based at least in part on the first generated value and the second generated value. In certain aspects, the shared information may be preconfigured at the first AP and the at least one second AP. The 1905.1 component 424 may be configured to determine a PMK based on the shared information. The 1905.1 component 424 may be configured to determine a temporary GTK and a key index associated with the GTK. The 1905.1 component 424 may be configured to determine a PTK when both the first AP and the at least one second AP use the PMK during the handshake communication. The 1905.1 component 424 may be configured to determine a MAC based at least in part on one of the GTK or a PTK. The 1905.1 component 424 may be configured to transmit the GTK and the key index to at least one second AP. In certain aspects, the GTK and the key index may be encrypted using the PTK when transmitted to the at least one second AP. The 1905.1 component 424 may be configured to transmit one or more messages to the at least one second AP using the communication link based on the 1905.1 protocol. In certain aspects, the MAC may be included in a MAC-TLV portion of each of the one or more messages. The 1905.1 component 424 may be configured to determine a keyed-HMAC for each of the one or more messages based at least in part on a message header and all TLVs excluding the MAC-TLV. In certain aspects, each of the one or more messages may include an incremented value. The 1905.1 component 424 may be configured to determine a new GTK when a timer expires at the first AP or when at least one of the second APs leaves a group associated with the GTK. The 1905.1 component 424 may be configured to transmit the new GTK and a new key index to the at least one second AP using the communication link based on the 1905.1 protocol. In certain aspects, the new GTK and the new key index may be encrypted when transmitted to the at least one second AP. The 1905.1 component 424 may be configured to receive an acknowledgement indicating that the new GTK is received by the at least one second AP. In certain aspects, the acknowledgement may be received via the communication link based on the 1905.1 protocol. In certain other aspects, the new key index may be included in new messages when the acknowledgement is received.

The various components of the communication device 402 may be coupled together by a bus system 426. The bus system 426 may include a data bus, for example, as well as a power bus, a control signal bus, and a status signal bus in addition to the data bus. Components of the communication device 402 may be coupled together or accept or provide inputs to each other using some other mechanism.

Although a number of separate components are illustrated in FIG. 4, one or more of the components may be combined or commonly implemented. For example, the processor 404 may be used to implement not only the functionality described above with respect to the processor 404, but also to implement the functionality described above with respect to the signal detector 418, the DSP 420, the user interface 422, and/or the 1905.1 component 424. Further, each of the components illustrated in FIG. 4 may be implemented using a plurality of separate elements.

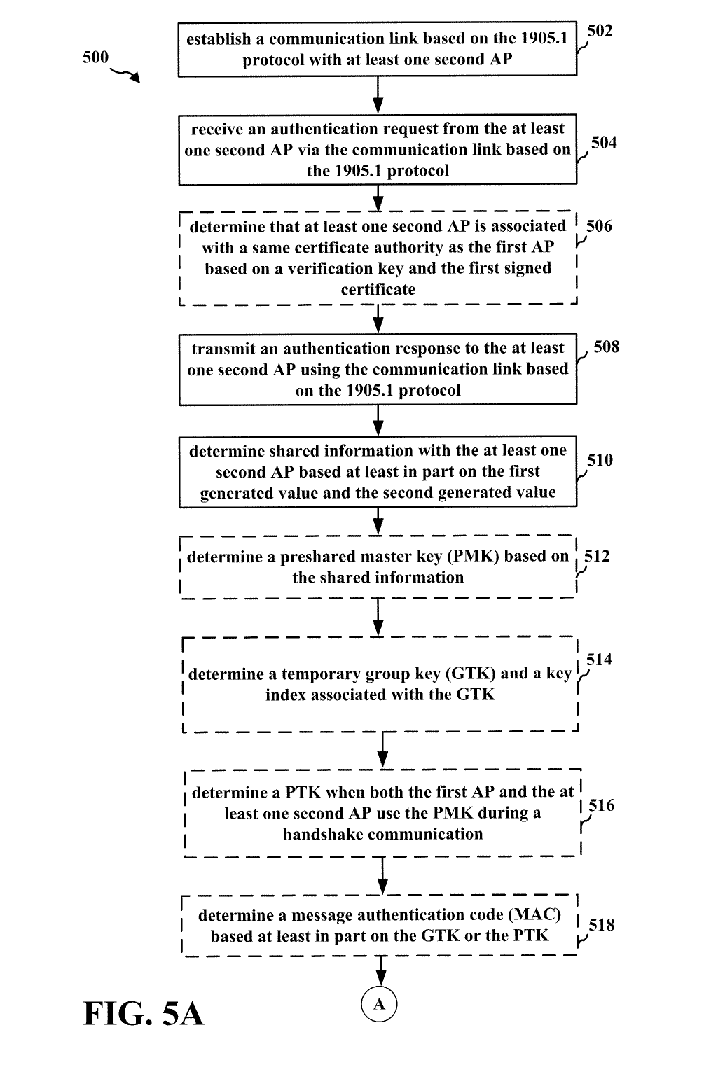

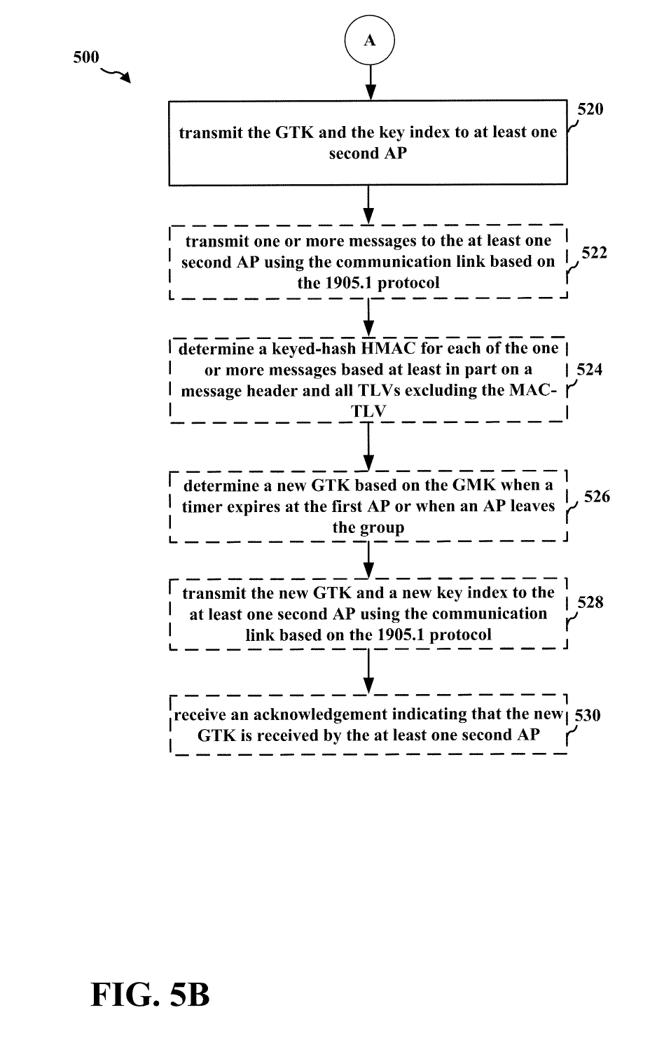

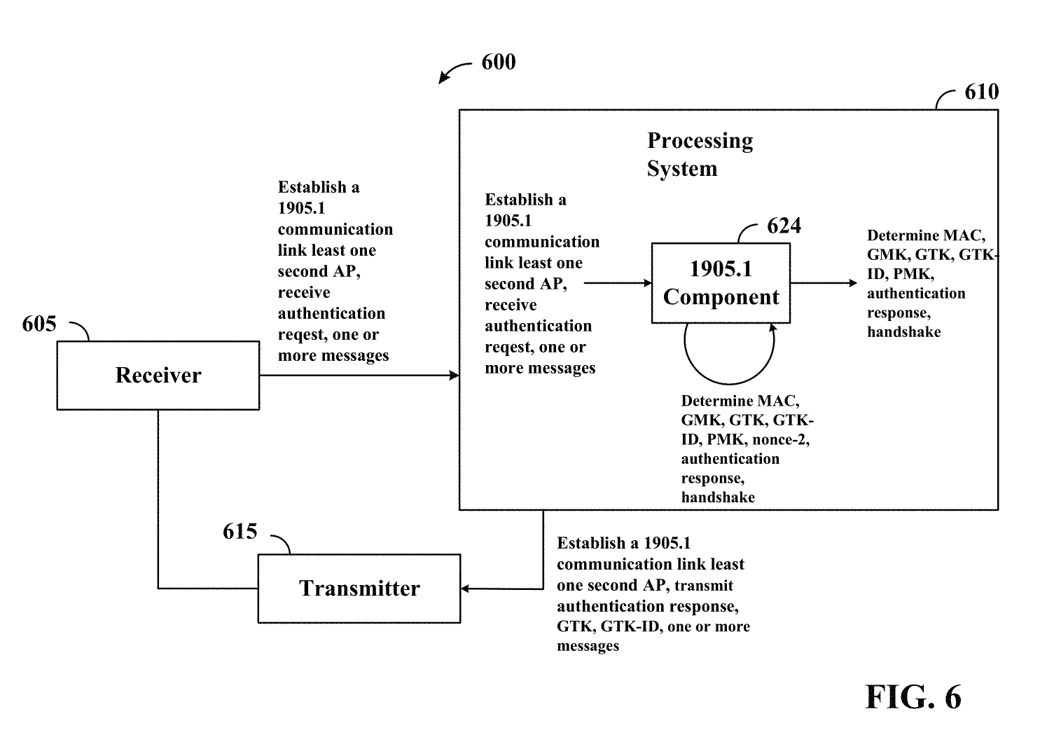

FIGS. 5A and 5B are a flowchart of an example method 500 of transmitting messages with MACs in order to determine that each device is a 1905.1 authorized device (e.g., or other wired or wireless protocol compatible device) in accordance with certain aspects of the disclosure. The method 500 may be performed using a first AP (e.g., the AP 104, the RAP 202, the RAP 302, or the communication device 402, for example). Although the method 500 is described below with respect to the elements of communication device 402 of FIG. 4, other components may be used to implement one or more of the steps described herein. The dotted lines in FIGS. 5A and 5B may indicate optional operations.

Referring to FIG. 5A, at 502, the first AP may establish a communication link based on the 1905.1 protocol with at least one second AP. For example, referring to FIG. 2A, the RAP 202 and the SAP 204 may perform an association procedure 201, 203, 205 to establish media access when, for example, a user presses a push button located on one or more of the RAP 202 and/or the SAP 204. In one aspect, the association procedure 201, 203, 205 may follow a WPS2.0 procedure and/or a programmable logic controller (PLC) procedure. In another aspect, the association procedure may include communicating one or more authentication requests/authentication responses 201 between the RAP 202 and the SAP 204. In a further aspect, the association procedure may include communicating one or more association requests/association responses 203 between the RAP 202 and the SAP 204. Additionally, the RAP 202 and the SAP 204 may perform a WPS 2.0 procedure 205 and/or a Wi-Fi simple configuration (WSC) protocol 205 by exchanging messages M1 to M8. In one aspect, the association procedure 201, 203, 205 may be performed using a Wi-Fi backhaul link, while the following description of the data flow 200 may be performed using the Wi-Fi backhaul and/or Wired backhaul link.

At 504, the first AP may receive an authentication request from the at least one second AP via the communication link based on the 1905.1 protocol. In certain aspects, the authentication request may include at least a first signed certificate and a first generated value. For example, referring to FIG. 2A, the RAP 302 may receive a device authentication request 209 that includes one or more of public credentials, Pₛₐₚ, sign(Pₛₐₚ), nonce-1, etc. from the SAP 204.

At 506, the first AP may determine if the at least one second AP is associated with a same certificate authority as the first AP based on a verification key and the first signed certificate. In certain aspects, the verification key may be a certificate authority digital signature. For example, referring to FIG. 2A, the RAP 202 may verify 211 and/or determine 211 the credentials (e.g., sign(Pₛₐₚ) of the SAP 204 using the verification key (e.g., Oᵥₑᵣᵢ).

At 508, the first AP may transmit an authentication response to the at least one second AP using the communication link based on the 1905.1 protocol. In certain aspects, the authentication response may include at least a second signed certificate and a second generated value. In certain other aspects, the authentication response may be transmitted when it is determined that the at least one second AP is associated with the same certificate authority as the first AP. For example, referring to FIG. 2B, the RAP 202 may transmit a device authentication response 215 that includes one or more of public credentials, Pᵣₐₚ, sign(Pᵣₐₚ), nonce-1, nonce-2, etc. to the SAP 204.

At 510, the first AP may determine shared information with the at least one second AP based at least in part on the first generated value and the second generated value. In certain aspects, the shared information may be preconfigured at the first AP and the at least one second AP. In certain aspects, the shared information may be used to generate one or more keys used to authenticate and optionally encrypt a message. For example, referring to FIG. 2B, the RAP 202 may determine shared information 219 (e.g., a shared secret N) using ECDH, a private key (e.g., sₛₐₚ and/or sᵣₐₚ), a public key (e.g., Pₛₐₚ and/or Pᵣₐₚ), the first generated value (e.g., nonce-1), and/or the second generated value (e.g., nonce-2).

At 512, the first AP may determine a PMK based on the shared information. For example, referring to FIG. 2C, the RAP 202 may determine a PMK 221. In certain aspects, the PMK 221 may be determined using one or more of a HKDF, the shared information 219 (e.g., N.x), the first generated value (e.g., nonce-1), and/or the second generated value (e.g., nonce-2).

At 514, the first AP may determine a GTK and a key index associated with the GTK. For example, referring to FIG. 2C, using the PMK 221 as additional shared information, the RAP 202 and the SAP 204 may perform a four-way handshake 223 to generate a GTK, and install the GTK-ID and GTK at each of the RAP 202 and the SAP 204.

At 516, the first AP may determine a PTK when both the first AP and the at least one second AP use the PMK during the handshake communication. For example, referring to FIG. 2C, using the PMK 221 as additional shared information, the RAP 202 and the SAP 204 may perform a four-way handshake 223 to derive the PTK, generate a GTK, and install the GTK at each of the RAP 202 and the SAP 204. In certain aspects, the PTK may be generated by concatenating one or more of the PMK, the first generated value (e.g., nonce-1), the second generated value (e.g., nonce-2), the RAP's 202 media access control address, and/or the SAP's 204 media access control address. The result of the concatenation may then be put through a pseudo-random function to generate the PTK.

At 518, the first AP may determine a MAC based at least in part on the GTK. For example, referring to FIG. 2C, the RAP 202 may determine a MAC 225 based on, e.g., the GTK.

At 520, the first AP may transmit the GTK and the key index to at least one second AP. In certain aspects, the GTK and the key index may be encrypted using the PTK when transmitted to the at least one second AP. For example, referring to FIG. 2C, using the PMK 221 as additional shared information, the RAP 202 and the SAP 204 may perform a four-way handshake 223 to derive the PTK, generate a GTK, and install the GTK at each of the RAP 202 and the SAP 204. In certain aspects, the GTK and GTK-ID may be transmitted by the RAP 202 to the SAP 204.

At 522, the first AP may transmit one or more messages to the at least one second AP using the communication link based on the 1905.1 protocol. In certain aspects, the MAC may be included in a MAC-TLV portion of each of the one or more messages. In certain aspects, each of the one or more messages may include an incremented value. For example, referring to FIG. 2C, one or more messages 229 may be transmitted from the RAP 202 to the SAP 204 that include the MAC, the GTK, and/or the GTK-ID. By including the MAC in each of the one or more messages 229 (e.g., the MAC being included in a MAC-TLV portion of each of the one or more messages 229), the authenticity and/or security of the messages may be increased. Furthermore, each message 229 that is transmitted by the RAP 202 and the SAP 204 may include an incremented number to help ensure anti-replay.

At 524, the first AP may determining a keyed-HMAC for each of the one or more messages based at least in part on a message header and all TLVs excluding the MAC-TLV. In certain aspects, the one or more TLVs may be encrypted and included in an ENC-TLV portion of each of the one or more messages. For example, referring to FIG. 2C, the RAP 202 may determine an keyed-HMAC for each of the one or more messages 229.

At 526, the first AP may determine a new GTK when a timer expires at the first AP or when a second AP of the one or more second APs leaves a group associated with the first AP. For example, referring to FIG. 3A, the RAP 302 may determine a new GTK′ 303 (e.g., GTK′) when one of the members (e.g., SAP3 304c) is leaving or has left the group of SAPs 304a, 304b, 304c. In addition, the RAP 302 may determine a new GTK-ID′ 305 associated with the new GTK′. Each time that a SAP “leaves” the network, the RAP 302 may determine a new GTK′ from the GMK (e.g., GMK is described above with respect to FIGS. 2A-2C) and distribute the new GTK′ to the SAPs remaining in the group.

At 528, the first AP may transmit the new GTK and a new key index to the at least one second AP using the communication link based on the 1905.1 protocol. In certain aspects, the new GTK and the new key index may be encrypted when transmitted to the at least one second AP. For example, referring to FIG. 2A, the RAP 302 may send a new group key message 307 to SAP1 304a. The new group key message 307 may include the new GTK′ 303 and the new GTK′-ID 305 encrypted with the PTK (e.g., either previously determined or a new PTK). The new GTK′ transmitted to the SAP 304a may be encrypted.

At 530, the first AP may receive an acknowledgement indicating that the new GTK is received by the at least one second AP. In certain aspects, the acknowledgement may be received via the communication link based on the 1905.1 protocol. For example, referring to FIG. 3A, the RAP 302 may receive a new group key message acknowledgement 309 from the SAP1 304a indicating that the new group key message 307 was received.

FIG. 6 is a functional block diagram of an example communication device 600 that may exchange a message authentication code with a second device. The communication device 600 may include a receiver 605, a processing system 610, and a transmitter 615. The processing system 610 may include a 1905.1 component 624. In certain aspects, the processing system 610, the 1905.1 component 624, the transmitter 615, and/or the receiver 605 may be configured to establish a communication link based on the 1905.1 protocol with at least one second AP. The processing system 610, the 1905.1 component 624, the transmitter 615, and/or the receiver 605 may be configured to receive an authentication request from the at least one second AP via the communication link based on the 1905.1 protocol. In certain aspects, the authentication request may include at least a first signed certificate and a first generated value. The processing system 610, the 1905.1 component 624, the transmitter 615, and/or the receiver 605 may be configured to determine if the at least one second AP is associated with a same certificate authority as the first AP based on a verification key and the first signed certificate. The processing system 610, the 1905.1 component 624, the transmitter 615, and/or the receiver 605 may be configured to transmit an authentication response to the at least one second AP using the communication link based on the 1905.1 protocol. In certain aspects, the authentication response may include at least a second signed certificate and a second generated value. In certain other aspects, the authentication response may be transmitted when it is determined that the at least one second AP is associated with the same certificate authority as the first AP. In certain other aspects, the verification key may be a certificate authority digital signature. The processing system 610, the 1905.1 component 624, the transmitter 615, and/or the receiver 605 may be configured to determine shared information with the at least one second AP based at least in part on the first generated value and the second generated value. In certain aspects, the shared information may be preconfigured at the first AP and the at least one second AP. The processing system 610, the 1905.1 component 624, the transmitter 615, and/or the receiver 605 may be configured to determine a PMK based on the shared information. The processing system 610, the 1905.1 component 624, the transmitter 615, and/or the receiver 605 may be configured to determine a GTK and a key index associated with the GTK. The processing system 610, the 1905.1 component 624, the transmitter 615, and/or the receiver 605 may be configured to determine a PTK when both the first AP and the at least one second AP use the PMK during the handshake communication. The processing system 610, the 1905.1 component 624, the transmitter 615, and/or the receiver 605 may be configured to determine a message authentication code (MAC) based at least in part on the GTK. The processing system 610, the 1905.1 component 624, the transmitter 615, and/or the receiver 605 may be configured to transmit the GTK and the key index to at least one second AP. In certain aspects, the GTK and the key index may be encrypted using the PTK when transmitted to the at least one second AP. The processing system 610, the 1905.1 component 624, the transmitter 615, and/or the receiver 605 may be configured to transmit one or more messages to the at least one second AP using the communication link based on the 1905.1 protocol. In certain aspects, the MAC may be included in a MAC type length value (TLV) (MAC-TLV) portion of each of the one or more messages. The processing system 610, the 1905.1 component 624, the transmitter 615, and/or the receiver 605 may be configured to determine a keyed-hash message authentication code (HMAC) for each of the one or more messages based at least in part on a message header and all type length values (TLVs) excluding the MAC-TLV. In certain aspects, each of the one or more messages may include an incremented value. The processing system 610, the 1905.1 component 624, the transmitter 615, and/or the receiver 605 may be configured to determine a new GTK based on the GMK when a timer expires at the first AP or when at least one of the second APs leaves a group associated with the GTK. The processing system 610, the 1905.1 component 624, the transmitter 615, and/or the receiver 605 may be configured to transmit the new GTK and a new key index to the at least one second AP using the communication link based on the 1905.1 protocol. In certain aspects, the new GTK and the new key index may be encrypted when transmitted to the at least one second AP. The processing system 610, the 1905.1 component 624, the transmitter 615, and/or the receiver 605 may be configured to receive an acknowledgement indicating that the new GTK is received by the at least one second AP. In certain aspects, the acknowledgement may be received via the communication link based on the 1905.1 protocol. In certain other aspects, the new key index may be included in new messages when the acknowledgement is received.

The receiver 605, the processing system 610, the 1905.1 component 624, and/or the transmitter 615 may be configured to perform one or more functions discussed above with respect to blocks 502, 504, 506, 508, 510, 512, 514, 516, 518, 520, 522, 524, 526, 528, 530 of FIGS. 5A and 5B. The receiver 605 may correspond to the receiver 412. The processing system 610 may correspond to the processor 404. The transmitter 615 may correspond to the transmitter 410. The 1905.1 component 624 may correspond to the 1905.1 component 124 and/or the 1905.1 component 424.

In one configuration, the communication device 600 may include means for establishing (e.g., the processing system 610, the 1905.1 component 624, the receiver 605, and/or the transmitter 615) a communication link based on the 1905.1 protocol with at least one second AP. The communication device 600 may include means for receiving (e.g., the processing system 610, the 1905.1 component 624, and/or the receiver 605) an authentication request from the at least one second AP via the communication link based on the 1905.1 protocol. In certain aspects, the authentication request may include at least a first signed certificate and a first generated value. The communication device 600 may include means for determining (e.g., the processing system 610 and/or the 1905.1 component 624) if the at least one second AP is associated with a same certificate authority as the first AP based on a verification key and the first signed certificate. The communication device 600 may include means for transmitting (e.g., the processing system 610, the 1905.1 component 624, and/or the transmitter 615) an authentication response to the at least one second AP using the communication link based on the 1905.1 protocol. In certain aspects, the authentication response may include at least a second signed certificate and a second generated value. In certain other aspects, the authentication response may be transmitted when it is determined that the at least one second AP is associated with the same certificate authority as the first AP. In certain other aspects, the verification key may be a certificate authority digital signature. The communication device 600 may include means for determining (e.g., the processing system 610 and/or the 1905.1 component 624) shared information with the at least one second AP based at least in part on the first generated value and the second generated value. In certain aspects, the shared information may be preconfigured at the first AP and the at least one second AP. The communication device 600 may include means for determining (e.g., the processing system 610 and/or the 1905.1 component 624) a PMK based on the shared information. The communication device 600 may include means for determining (e.g., the processing system 610 and/or the 1905.1 component 624) a GTK and a key index associated with the GTK. The communication device 600 may include means for determining (e.g., the processing system 610 and/or the 1905.1 component 624) a PTK when both the first AP and the at least one second AP use the PMK during the handshake communication. The communication device 600 may include means for determining (e.g., the processing system 610 and/or the 1905.1 component 624) a MAC based at least in part on the GTK. The communication device 600 may include means for transmitting (e.g., the processing system 610, the 1905.1 component 624, and/or the transmitter 615) the GTK and the key index to at least one second AP. In certain aspects, the GTK and the key index may be encrypted using the PTK when transmitted to the at least one second AP. The communication device 600 may include means for transmitting (e.g., the processing system 610, the 1905.1 component 624, and/or the transmitter 615) one or more messages to the at least one second AP using the communication link based on the 1905.1 protocol. In certain aspects, the MAC may be included in a MAC-TLV portion of each of the one or more messages. The communication device 600 may include means for determining (e.g., the processing system 610 and/or the 1905.1 component 624) a keyed-HMAC for each of the one or more messages based at least in part on a message header and all TLVs excluding the MAC-TLV. In certain aspects, each of the one or more messages may include an incremented value. The communication device 600 may include means for determining (e.g., the processing system 610 and/or the 1905.1 component 624) a new GTK based on the GMK when a timer expires at the first AP or when at least one of the second APs leaves a group associated with the GTK. The communication device 600 may include means for transmitting (e.g., the processing system 610, the 1905.1 component 624, and/or the transmitter 615) the new GTK and a new key index to the at least one second AP using the communication link based on the 1905.1 protocol. In certain aspects, the new GTK and the new key index may be encrypted when transmitted to the at least one second AP. The communication device 600 may include means for receiving (e.g., the processing system 610, the 1905.1 component 624, and/or the receiver 605) an acknowledgement indicating that the new GTK is received by the at least one second AP. In certain aspects, the acknowledgement may be received via the communication link based on the 1905.1 protocol. In certain other aspects, the new key index may be included in new messages when the acknowledgement is received.

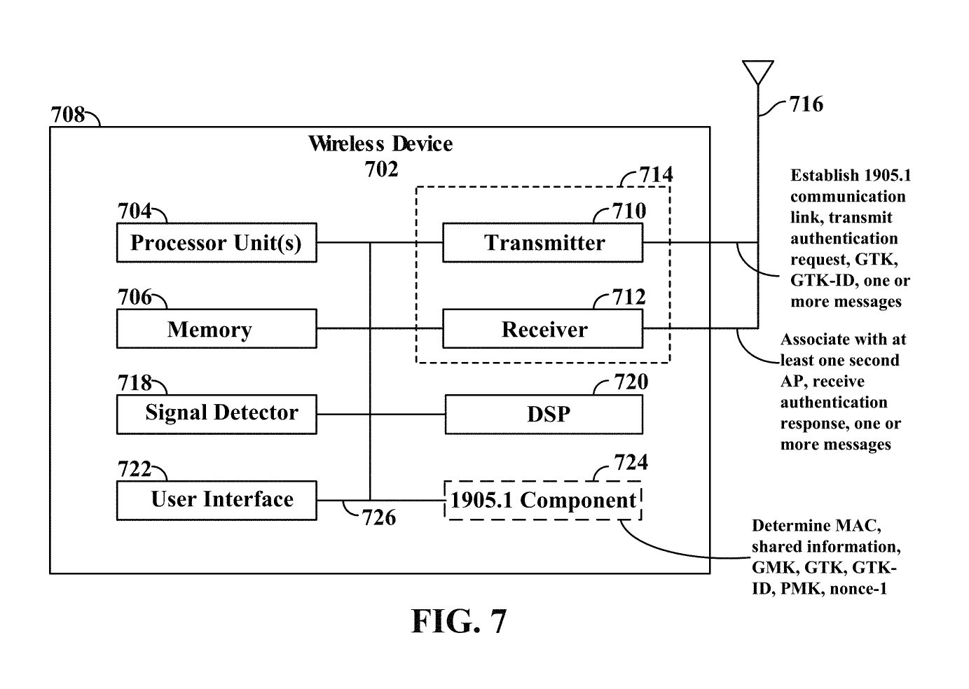

FIG. 7 shows an example functional block diagram of a communication device 702 that may exchange a MAC with a second device within the communication system 100 of FIG. 1A. The communication device 702 is an example of a device that may be configured to implement the various methods described herein. For example, the communication device 702 may comprise the AP 114, SAP 204, SAP1, 304a, SAP2 304b, SAP3 304c.

The communication device 702 may include a processor 704 which controls operation of the communication device 702. The processor 704 may also be referred to as a CPU. Memory 706, which may include both ROM and RAM, may provide instructions and data to the processor 704. A portion of the memory 706 may also include NVRAM. The processor 704 typically performs logical and arithmetic operations based on program instructions stored within the memory 706. The instructions in the memory 706 may be executable (by the processor 704, for example) to implement the methods described herein.

The processor 704 may comprise or be a component of a processing system implemented with one or more processors. The one or more processors may be implemented with any combination of general-purpose microprocessors, microcontrollers, DSPs, FPGAs, PLDs, controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The communication device 702 may also include a housing 708, and the communication device 702 may include a transmitter 710 and/or a receiver 712 to allow transmission and reception of data between the communication device 702 and a remote device. The transmitter 710 and the receiver 712 may be combined into a transceiver 714. An antenna 716 may be attached to the housing 708 and electrically coupled to the transceiver 714. The communication device 702 may also include multiple transmitters, multiple receivers, multiple transceivers, and/or multiple antennas.

The communication device 702 may also include a signal detector 718 that may be used to detect and quantify the level of signals received by the transceiver 714 or the receiver 712. The signal detector 718 may detect such signals as total energy, energy per subcarrier per symbol, power spectral density, and other signals. The communication device 702 may also include a DSP 720 for use in processing signals. The DSP 720 may be configured to generate a packet for transmission. In some aspects, the packet may comprise a PPDU.

The communication device 702 may further comprise a user interface 722 in some aspects. The user interface 722 may comprise a keypad, a microphone, a speaker, and/or a display. The user interface 722 may include any element or component that conveys information to a user of the communication device 702 and/or receives input from the user.

When the communication device 702 is implemented as an SAP (e.g., the AP 114, SAP 204, SAP1 304a, SAP2 304b, SAP3 304c), the communication device 702 may also comprise a 1905.1 component 724. The 1905.1 component 724 may be configured to perform procedures related to determining and/or exchanging MACs with messages sent to and/or from a second AP (e.g., RAP 104). In the example, the 1905.1 component 724 may be configured to establish a communication link based on the 1905.1 protocol with a second AP. The 1905.1 component 724 may be configured to transmit an authentication request to the second AP using the communication link based on the 1905.1 protocol. In certain aspects, the authentication request may include at least a first signed certificate and a first generated value. The 1905.1 component 724 may be configured to determine if the second AP is associated with a same certificate authority as the first AP based on a verification key and the second signed certificate. In certain aspects, the verification key may be a certificate authority digital signature associated with the same certificate authority. The 1905.1 component 724 may be configured to receive an authentication response from the second AP via the communication link based on the 1905.1 protocol. In certain aspects, the authentication response may include at least a second signed certificate and a second generated value. The 1905.1 component 724 may be configured to determine shared information with the second AP based at least in part on the first generated value and the second generated value. In certain aspects, the shared information may be preconfigured at the first AP and the second AP. The 1905.1 component 724 may be configured to determine a PMK based on the shared information with the at least one second AP. The 1905.1 component 724 may be configured to receive a temporary GTK and a key index associated with the GTK from the second AP. The 1905.1 component 724 may be configured to determine a MAC based at least in part on one of the GTK or a PTK. The 1905.1 component 724 may be configured to receive one or more messages from the second AP via the communication link based on the 1905.1 protocol. In certain aspects, a MAC may be included in a MAC-TLV portion of each of the one or more messages. The 1905.1 component 724 may be configured to receive a new GTK and a new key index from second AP using the communication link based on the 1905.1 protocol upon the expiration of a timer or when a different access point leaves a multi-access point group associated with the first AP. The 1905.1 component 724 may be configured to transmit an acknowledgement indicating that the new GTK is received to the second AP. In certain aspects, the acknowledgement may be transmitted using the communication link based on the 1905.1 protocol. In certain other aspects, the new key index may be included in new messages when the acknowledgement is transmitted.

The various components of the communication device 702 may be coupled together by a bus system 726. The bus system 726 may include a data bus, for example, as well as a power bus, a control signal bus, and a status signal bus in addition to the data bus. Components of the communication device 702 may be coupled together or accept or provide inputs to each other using some other mechanism.

Although a number of separate components are illustrated in FIG. 7, one or more of the components may be combined or commonly implemented. For example, the processor 704 may be used to implement not only the functionality described above with respect to the processor 704, but also to implement the functionality described above with respect to the signal detector 718, the DSP 720, the user interface 722, and/or the 1905.1 component 724. Further, each of the components illustrated in FIG. 7 may be implemented using a plurality of separate elements.

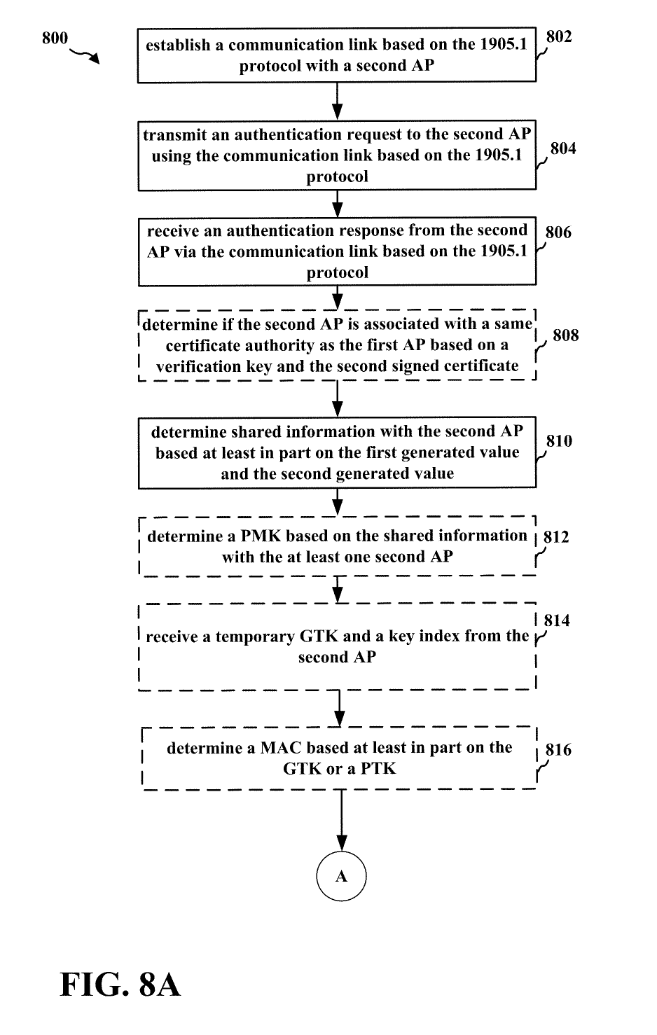

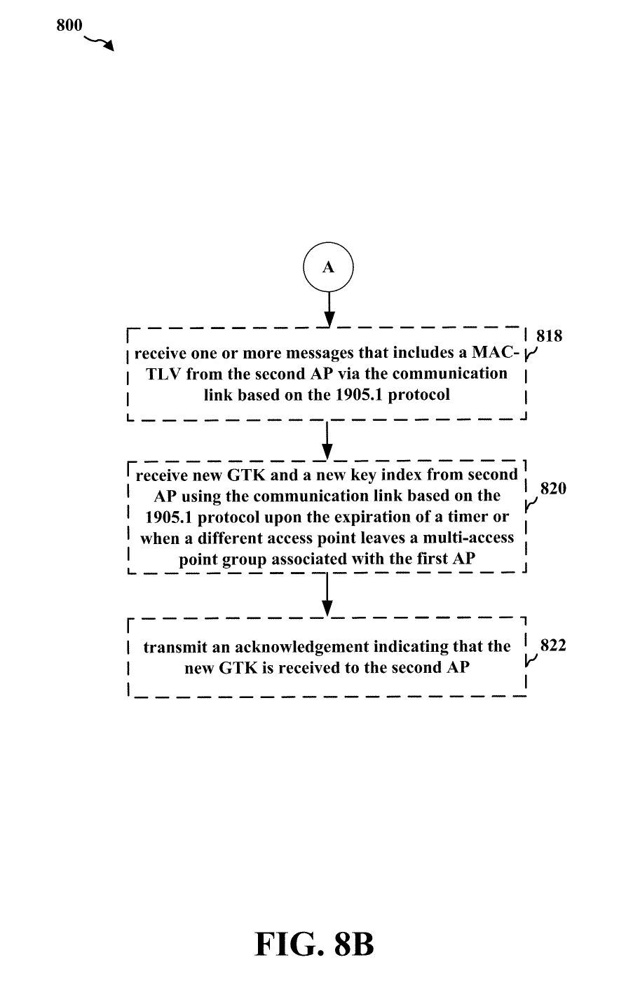

FIGS. 8A and 8B are a flowchart of an example method 800 of transmitting messages with MACs in order to determine that each device is a 1905.1 authorized device (e.g., or other wired or wireless protocol compatible device) in accordance with certain aspects of the disclosure. The method 800 may be performed using a first AP (e.g., the AP 114, the SAP 204, the SAP1 304a, the SAP2 304b, the SAP3 304c, or the communication device 702, for example). Although the method 800 is described below with respect to the elements of communication device 702 of FIG. 7, other components may be used to implement one or more of the steps described herein. The dotted lines in FIGS. 8A and 8B may indicate optional operations.

Referring to FIG. 8A, at 802, the first AP may establish a communication link based on the 1905.1 protocol with a second AP. For example, referring to FIG. 2A, the RAP 202 and the SAP 204 may perform an association procedure 201, 203, 205 to establish media access when, for example, a user presses a push button located on one or more of the RAP 202 and/or the SAP 204. In one aspect, the association procedure 201, 203, 205 may follow a WPS2.0 procedure and/or a PLC procedure. In another aspect, the association procedure may include communicating one or more authentication requests/authentication responses 201 between the RAP 202 and the SAP 204. In a further aspect, the association procedure may include communicating one or more association requests/association responses 203 between the RAP 202 and the SAP 204. Additionally, the RAP 202 and the SAP 204 may perform a WPS 2.0 procedure 205 and/or a WSC protocol 205 by exchanging messages M1 to M8. In one aspect, the association procedure 201, 203, 205 may be performed using a Wi-Fi backhaul link.

At 804, the first AP may transmit an authentication request to the second AP using the communication link based on the 1905.1 protocol. In certain aspects, the authentication request may include at least a first signed certificate and a first generated value. For example, referring to FIG. 2A, the SAP 204 may transmit a device authentication request 209 that includes one or more of public credentials, Pₛₐₚ, sign(Pₛₐₚ), nonce-1, etc. to the RAP 202.

At 806, the first AP may receive an authentication response from the second AP via the communication link based on the 1905.1 protocol, the authentication response including at least a second signed certificate and a second generated value. For example, referring to FIG. 2B, the SAP 204 may receive a device authentication response 215 from the RAP 202 that includes one or more of public credentials, Pᵣₐₚ, sign(Pᵣₐₚ), nonce-1, nonce-2, etc. to the SAP 204.

At 808, the first AP may determine if the second AP is associated with a same certificate authority as the first AP based on a verification key and the second signed certificate. In certain aspects, the verification key may be a certificate authority digital signature associated with the same certificate authority. For example, referring to FIG. 2B, the SAP 204 may verify 217 the credentials (e.g., sign(Pᵣₐₚ)) of the SAP 204 using the verification key (e.g., Oᵥₑᵣᵢ) of the certificate authority that is preconfigured at the SAP 204

At 810, the first AP may determine shared information with the second AP based at least in part on the first generated value and the second generated value. In certain aspects, the shared information may be preconfigured at the first AP and the second AP. In certain other aspects, the shared information may be used to generate one or more keys used to authenticate and optionally encrypt a message. For example, referring to FIG. 2B, each of the RAP 202 and the SAP 204 may determine shared information 219 (e.g., a shared secret N) using one or more of an ECDH, a private key (e.g., sₛₐₚ and/or sᵣₐₚ), a public key (e.g., Pₛₐₚ and/or Pᵣₐₚ), the first generated value (e.g., nonce-1), and/or the second generated value (e.g., nonce-2) when the credentials of the other device are verified. In certain configurations, the shared information 219 may be used to derive one or more keys (e.g., PMK, GTK, GMK, etc.) that may be used to generate one or more MACs. In one aspect, the PMK, GTK, and/or GMK discussed below may be derived and/or determined from the shared information 219 using a keyed-hash message authentication code (HMAC)-based Extract-and-Expand Key Derivation Function (HKDF) with a hash function (e.g., SHA256, etc.). Additionally, the shared information 219 be used for various purposes, e.g., initiate WPA2.0 procedures to derive additional shared information and/or group secrets for further use in the data flow 200.

At 812, the first AP may determine a PMK based on the shared information with the at least one second AP. For example, referring to FIG. 2C, each of the RAP 202 and the SAP 204 may determine a PMK 221. In a first example, the PMK 221 may be determined using one or more of a HKDF, the shared information 219 (e.g., N.x), the first generated value (e.g., nonce-1), and/or the second generated value (e.g., nonce-2). In a second example, the PMK 221 may be determined using public key agreement protocols and/or using the public key credentials preconfigured at the RAP 202 and SAP 204 followed by 4-way handshake procedure. In a third example, the PMK 221 may be determined based on a preconfigured symmetric key. The preconfigured symmetric key may be set to PMK and the 4-way handshake may be executed. The third example may provide less security than the first example and/or the second example, because each of the RAP 202 and the SAP 204 may be is preconfigured with the same shared secret. In a fourth example, in instances of the extended authentication framework, i.e., Wi-Fi Simple Configuration (e.g., for use over the Wi-Fi backhaul channel), the RAP 202 and the SAP 204 may determine a pairwise secret; expand the pairwise secret using a pseudo-random function to a random number and set it to PMK (e.g., the seed to the pseudo-random function may be nonce-1, nonce-2, different nonces, and/or media access control address(es)). The RAP 202 and the SAP 204 may then perform the 4-way handshake. In certain aspects, the fourth example may provide additional security if the expansion of the determined pairwise secret has increased complexity as compared to the shared secrets described above in connection with the first example, the second example, and the third example. However, in certain other aspects, the fourth example may provide less security than the first, second, and/or third example described above because a pseudo-random function may be used instead of a HKDF to derive the PMK, and nonces may be intercepted as well as the media access control addresses by an eavesdropper. The PMK is designed to last as long as the 1905.1 communication link is maintained, and hence, should be exposed as little as possible.

At 814, the first AP may receive a GTK and a key index associated with the GTK from the second AP. For example, referring to FIG. 2C, using the PMK 221 as additional shared information, the RAP 202 and the SAP 204 may perform a four-way handshake 223 to determine a GTK and install the GTK at each of the RAP 202 and the SAP 204. In certain configurations, the RAP 202 may determine the GTK and GTK-ID that are sent to the SAP 204.

At 816, the first AP may determine a MAC based at least in part on the GTK. For example, referring to FIG. 2C, one or more of the RAP 202 and/or the SAP 204 may determine a MAC 225 based on, e.g., the GTK.

Referring to FIG. 8B, at 818, the first AP may receive one or more messages from the second AP via the communication link based on the 1905.1 protocol. In certain aspects, the MAC may be included in a MAC-TLV portion of each of the one or more messages. In certain aspects, a plurality of type length values TLVs may be included in each of the one or more messages and these TLVs are encrypted and included in an encrypted TLV (ENC-TLV) portion of each of the one or more messages. For example, referring to FIG. 2C, one or more messages 229 may be transmitted from the RAP 202 to the SAP 204 that include the MAC, the GTK, and/or the GTK-index (ID)).

At 820, the first AP may a receive new GTK and a new key index from the second AP using the communication link based on the 1905.1 protocol upon the expiration of a timer or when a different access point leaves a multi-access point group associated with the first AP. In certain aspects, the new GTK and the new key index may be encrypted. For example, referring to FIG. 3A, the RAP 302 may send a new group key message 307 that includes the new GTK′ 303, the new GTK′-ID 305, and the PTK (e.g., either previously determined or a new PTK) to SAP1 304a.

At 822, the first AP may transmit an acknowledgement indicating that the new GTK is received to the second AP. In certain aspects, the acknowledgement may be transmitted using the communication link based on the 1905.1 protocol. For example, referring to FIG. 3A, SAP1 304a may respond with a new group key message acknowledgement 309 indicating that the new group key message 307 was received.

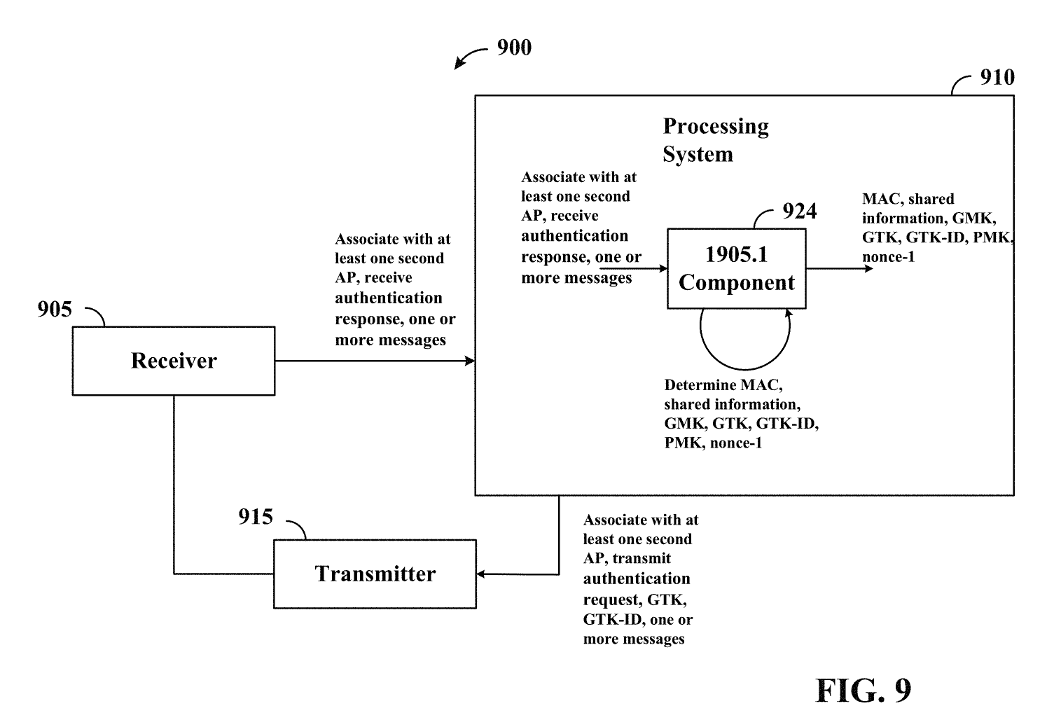

FIG. 9 is a functional block diagram of an example communication device 900 for exchanging a message authentication code with a second device. The communication device 900 may include a receiver 905, a processing system 910, and a transmitter 915. The processing system 910 may include a 1905.1 component 924. The processing system 910, the 1905.1 component 924, the receiver 905, and/or the transmitter 915 may be configured to establish a communication link based on the 1905.1 protocol with a second AP. The processing system 910, the 1905.1 component 924, and/or the transmitter 915 may be configured to transmit an authentication request to the second AP using the communication link based on the 1905.1 protocol. In certain aspects, the authentication request may include at least a first signed certificate and a first generated value. The processing system 910 and/or the 1905.1 component 924 may be configured to determine if the second AP is associated with a same certificate authority as the first AP based on a verification key and the second signed certificate. In certain aspects, the verification key may be a certificate authority digital signature associated with the same certificate authority. The processing system 910, the 1905.1 component 924, and/or the receiver 905 may be configured to receive an authentication response from the second AP via the communication link based on the 1905.1 protocol. In certain aspects, the authentication response may include at least a second signed certificate and a second generated value. The processing system 910 and/or the 1905.1 component 924 may be configured to determine shared information with the second AP based at least in part on the first generated value and the second generated value. In certain aspects, the shared information may be preconfigured at the first AP and the second AP. The processing system 910 and/or the 1905.1 component 924 may be configured to determine a PMK based on the shared information with the at least one second AP. The processing system 910, the 1905.1 component 924, and/or the receiver 905 may be configured to receive a temporary GTK and a key index associated with the GTK from the second AP. The processing system 910 and/or the 1905.1 component 924 may be configured to determine a MAC based at least in part on one of the GTK or a PTK. The processing system 910, the 1905.1 component 924, and/or the receiver 905 may be configured to receive one or more messages from the second AP via the communication link based on the 1905.1 protocol. In certain aspects, a MAC may be included in a MAC-TLV portion of each of the one or more messages. The processing system 910, the 1905.1 component 924, and/or the receiver 905 may be configured to receive a new GTK and a new key index from second AP using the communication link based on the 1905.1 protocol upon the expiration of a timer or when a different access point leaves a multi-access point group associated with the first AP. In certain aspects, the new GTK and the new key index may be encrypted. The processing system 910, the 1905.1 component 924, and/or the transmitter 915 may be configured to transmit an acknowledgement indicating that the new GTK is received to the second AP. In certain aspects, the acknowledgement may be transmitted using the communication link based on the 1905.1 protocol. In certain other aspects, the new key index may be included in new messages when the acknowledgement is transmitted.

The receiver 905, the processing system 910, the 1905.1 component 924, and/or the transmitter 915 may be configured to perform one or more functions discussed above with respect to blocks 802, 804, 806, 808, 810, 812, 814, 816, 818, 820, 822 of FIGS. 8A and 8B. The receiver 905 may correspond to the receiver 712. The processing system 910 may correspond to the processor 704. The transmitter 915 may correspond to the transmitter 710. The 1905.1 component 924 may correspond to the 1905.1 component 126 and/or the 1905.1 component 724.

In one configuration, the communication device 900 may include means for establishing (e.g., the processing system 910, the 1905.1 component 924, the receiver 905, and/or the transmitter 915) a communication link based on the 1905.1 protocol with a second AP. The communication device 900 may include means for transmitting (e.g., the processing system 910, the 1905.1 component 924, and/or the transmitter 915) an authentication request to the second AP using the communication link based on the 1905.1 protocol. In certain aspects, the authentication request may include at least a first signed certificate and a first generated value. The communication device 900 may include means for determining (e.g., the processing system 910 and/or the 1905.1 component 924) if the second AP is associated with a same certificate authority as the first AP based on a verification key and the second signed certificate. In certain aspects, the verification key may be a certificate authority digital signature associated with the same certificate authority. The communication device 900 may include means for receiving (e.g., the processing system 910, the 1905.1 component 924, and/or receiver 905) an authentication response from the second AP via the communication link based on the 1905.1 protocol. In certain aspects, the authentication response may include at least a second signed certificate and a second generated value. The communication device 900 may include means for determining (e.g., the processing system 910 and/or the 1905.1 component 924) shared information with the second AP based at least in part on the first generated value and the second generated value. In certain aspects, the shared information may be preconfigured at the first AP and the second AP. The communication device 900 may include means for determining (e.g., the processing system 910 and/or the 1905.1 component 924) a PMK based on the shared information with the at least one second AP. The communication device 900 may include means for receiving (e.g., the processing system 910, the 1905.1 component 924, and/or receiver 905) a temporary GTK and a key index associated with the GTK from the second AP. The communication device 900 may include means for determining (e.g., the processing system 910 and/or the 1905.1 component 924) a MAC based at least in part on the GTK. The communication device 900 may include means for receiving (e.g., the processing system 910, the 1905.1 component 924, and/or receiver 905) one or more messages from the second AP via the communication link based on the 1905.1 protocol. In certain aspects, a MAC may be included in a MAC-TLV portion of each of the one or more messages. The communication device 900 may include means for receiving (e.g., the processing system 910, the 1905.1 component 924, and/or receiver 905) a new GTK and a new key index from second AP using the communication link based on the 1905.1 protocol upon the expiration of a timer or when a different access point leaves a multi-access point group associated with the first AP. In certain aspects, the new GTK and the new key index may be encrypted. The communication device 900 may include means for transmitting (e.g., the processing system 910, the 1905.1 component 924, and/or transmitter 915) an acknowledgement indicating that the new GTK is received to the second AP. In certain aspects, the acknowledgement may be transmitted using the communication link based on the 1905.1 protocol. In certain other aspects, the new key index may be included in new messages when the acknowledgement is transmitted.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wired or wireless communication for a first access point (AP), the first AP configured to implement a 1905.1 protocol, the method comprising:
establishing a communication link based on the 1905.1 protocol with at least one second AP;
receiving an authentication request from the at least one second AP via the communication link based on the 1905.1 protocol, the authentication request including at least a first signed certificate and a first generated value;
transmitting an authentication response to the at least one second AP using the communication link based on the 1905.1 protocol, the authentication response including at least a second signed certificate and a second generated value; and
determining shared information with the at least one second AP based at least in part on the first generated value and the second generated value, the shared information being used to generate one or more keys used to authenticate a message.

2. The method of claim 1, further comprising:
determining if the at least one second AP is associated with a same certificate authority as the first AP based on a verification key and the first signed certificate,
wherein the authentication response is transmitted when it is determined that the at least one second AP is associated with the same certificate authority as the first AP.

3. The method of claim 2, wherein the verification key is a certificate authority digital signature.

4. The method of claim 1, further comprising:
determining a pairwise master key (PMK) based on the shared information;
determining a group transient key (GTK) and a key index associated with the GTK;
determining a message authentication code (MAC) based at least in part on one of the GTK or a pairwise transient key (PTK);
transmitting the GTK and the key index to at least one second AP; and
transmitting one or more messages to the at least one second AP using the communication link based on the 1905.1 protocol, the MAC being included in a MAC type length value (TLV) (MAC-TLV) portion of each of the one or more messages.

5. The method of claim 4, further comprising:
determining the PTK when both the first AP and the at least one second AP use the PMK during the handshake communication,
wherein the GTK and the key index are encrypted using the PTK when transmitted to the at least one second AP.

6. The method of claim 4, further comprising:
determining a keyed-hash message authentication code (HMAC) for each of the one or more messages based at least in part on a message header and all type length values (TLVs) excluding the MAC-TLV.

7. The method of claim 4, wherein each of the one or more messages includes an incremented value.

8. The method of claim 1, further comprising:
determining a new GTK when one of the at least one second AP leaves a group associated with the first AP or when a timer expires at the first AP.

9. The method of claim 8, further comprising:
transmitting the new GTK and a new key index to the at least one second AP using the communication link based on the 1905.1 protocol, the new GTK and the new key index being encrypted when transmitted to the at least one second AP.

10. The method of claim 9, further comprising:
receiving an acknowledgement indicating that the new GTK is received by the at least one second AP, the acknowledgement being received via the communication link based on the 1905.1 protocol, and the new key index being included in new messages when the acknowledgement is received.

11. The method of claim 6, wherein the one or more TLVs are encrypted and included in an encrypted TLV (ENC-TLV) portion of each of the one or more messages.

12. The method of claim 1, wherein the first AP includes a multi-AP controller.

13. A method of wired or wireless communication for a first access point (AP), the first AP configured to implement a 1905.1 protocol, the method comprising:
establishing a communication link based on the 1905.1 protocol with a second AP;
transmitting an authentication request to the second AP using the communication link based on the 1905.1 protocol, the authentication request including at least a first signed certificate and a first generated value;
receiving an authentication response from the second AP via the communication link based on the 1905.1 protocol, the authentication response including at least a second signed certificate and a second generated value; and
determining shared information with the second AP based at least in part on the first generated value and the second generated value, the shared information being used to generate one or more keys used to authenticate a message.

14. The method of claim 13, further comprising:
determining if the second AP is associated with a same certificate authority as the first AP based on a verification key and the second signed certificate, the verification key being a certificate authority digital signature associated with the same certificate authority.

15. The method of claim 13, further comprising:
determining a preshared master key (PMK) based on the shared information with the second AP;
receiving a group transient key (GTK) and a key index from the second AP;
determining a message authentication code (MAC) based at least in part on the GTK or a pairwise transient key (PTK); and
receiving one or more messages from the second AP via the communication link based on the 1905.1 protocol, the MAC being included in a MAC type length value (TLV) (MAC-TLV) portion of each of the one or more messages.

16. The method of claim 13, further comprising:
receiving a new GTK and a new key index from the second AP using the communication link based on the 1905.1 protocol upon the expiration of a timer or when a different AP leaves a multi-access point group associated with the first AP, the new GTK and the new key index being encrypted.

17. The method of claim 16, further comprising:
transmitting an acknowledgement indicating that the new GTK is received to the second AP, the acknowledgement being transmitted using the communication link based on the 1905.1 protocol, and including the new key index in new messages upon transmission of the acknowledgement.

18. The method of claim 15, wherein a plurality of type length values (TLVs) included in each of the one or more messages are encrypted and included in an encrypted TLV (ENC-TLV) portion of each of the one or more messages.

19. The method of claim 13, wherein the second AP includes a multi-AP controller.

20. An apparatus for wired or wireless communication for a first access point (AP), the first AP configured to implement a 1905.1 protocol, the apparatus comprising:
a memory; and
at least one processor coupled to the memory and configured to:
establish a communication link based on the 1905.1 protocol with at least one second AP;
receive an authentication request from the at least one second AP via the communication link based on the 1905.1 protocol, the authentication request including at least a first signed certificate and a first generated value;
transmit an authentication response to the at least one second AP using the communication link based on the 1905.1 protocol, the authentication response including at least a second signed certificate and a second generated value; and
determine shared information with the at least one second AP based at least in part on the first generated value and the second generated value, the shared information being used to generate one or more keys used to authenticate a message.

21. The apparatus of claim 20, wherein the at least one processor is further configured to:
determine if the at least one second AP is associated with a same certificate authority as the first AP based on a verification key and the first signed certificate,
wherein the authentication response is transmitted when it is determined that the at least one second AP is associated with the same certificate authority as the first AP.

22. The apparatus of claim 21, wherein the verification key is a certificate authority digital signature.

23. The apparatus of claim 20, wherein the at least one processor is further configured to:
determine a preshared master key (PMK) based on the shared information;
determine a group transient key (GTK) and a key index associated with the GTK based on a handshake communication with the at least one second AP and the PMK;
determine a message authentication code (MAC) based at least in part on the GTK or a pairwise transient key (PTK);
transmit the GTK and the key index to at least one second AP; and
transmit one or more messages to the at least one second AP using the communication link based on the 1905.1 protocol, the MAC being included in a MAC type length value (TLV) (MAC-TLV) portion of each of the one or more messages.

24. The apparatus of claim 23, wherein the at least one processor is further configured to:
determine the PTK when both the first AP and the at least one second AP use the PMK during the handshake communication,
wherein the GTK and the key index are encrypted using the PTK when transmitted to the at least one second AP.

25. The apparatus of claim 23, wherein the at least one processor is further configured to:
determine a keyed-hash message authentication code (HMAC) for each of the one or more messages based at least in part on a message header and all type length values (TLVs) excluding the MAC-TLV.

26. The apparatus of claim 23, wherein each of the one or more messages includes an incremented value.

27. The apparatus of claim 20, wherein the at least one processor is further configured to:
determine a new GTK based on a group master key (GMK) when one of the at least one second AP leaves a group associated with the first AP or when a timer expires at the first AP.

28. The apparatus of claim 27, wherein the at least one processor is further configured to:
transmit the new GTK and a new key index to the at least one second AP using the communication link based on the 1905.1 protocol.

29. The apparatus of claim 28, wherein the at least one processor is further configured to:
receive an acknowledgement indicating that the new GTK is received by the at least one second AP, the acknowledgement being received via the communication link based on the 1905.1 protocol, and the new key index being included in new messages when the acknowledgement is received.

30. An apparatus for wired or wireless communication for a first access point (AP), the first AP configured to implement a 1905.1 protocol, the apparatus comprising:
a memory; and
at least one processor coupled to the memory and configured to:
establish a communication link based on the 1905.1 protocol with a second AP;
transmit an authentication request to the second AP using the communication link based on the 1905.1 protocol, the authentication request including at least a first signed certificate and a first generated value;
receive an authentication response from the second AP via the communication link based on the 1905.1 protocol, the authentication response including at least a second signed certificate and a second generated value; and
determine shared information with the second AP based at least in part on the first generated value and the second generated value, the shared information being used to generate one or more keys used to authenticate a message.
